(19) United States
(12) Patent Application Publication
(10) Pub. No.: US 2023/0273839 A1
(43) Pub. Date: Aug. 31, 2023

(54) METHODS AND APPARATUS TO BALANCE AND COORDINATE POWER AND COOLING SYSTEMS FOR COMPUTE COMPONENTS

(71) Applicant: Intel Corporation, Santa Clara, CA (US)

(72) Inventors: Francesc Guim Bernat, Barcelona (ES); Arun Hodigere, Bangalore (IN); John J. Browne, Limerick (IE); Henning Schroeder, Karlsruhe (DE); Kshitij Arun Doshi, Tempe, AZ (US)

(21) Appl. No.: 18/311,047

(22) Filed: May 2, 2023

(30) Foreign Application Priority Data
Dec. 30, 2022 (IN) 202241077199

(51) Int. Cl. G06F 9/50; G06F 1/20

(52) U.S. Cl. CPC G06F 9/5094; G06F 1/206

(57) ABSTRACT

An example apparatus to balance and coordinate power and cooling includes memory; machine-readable instructions; and programmable circuitry to execute the machine-readable instructions to: determine a first service level objective based on a service level agreement and resource data; modify the first service level objective to generate a second service level objective based on the first service level objective and an ambient temperature prediction; determine a resource budget based on a resource usage prediction, the resource budget to identify available resources at a given time; and cause an allocation of cooling resources and power resources for a compute component based on the second service level objective and the resource budget.

### RELATED APPLICATION

This patent claims the benefit of IN Provisional Patent Application No. 202241077199, which was filed on Dec. 30, 2022. IN Provisional Patent Application No. 202241077199 is hereby incorporated herein by reference in its entirety. Priority to IN Provisional Patent Application No. 202241077199 is hereby claimed.

### FIELD OF THE DISCLOSURE

This disclosure relates generally to compute components and, more particularly, to methods and apparatus to balance and coordinate power and cooling systems for compute components.

### BACKGROUND

Liquid cooling can be used to cool electronic components by facilitating a flow of relatively cool liquid coolant over the electronic components to promote dissipation of heat. In some instances, the use of liquids to cool electronic components is being explored to address thermal management risks resulting from increased thermal design power in high performance systems (e.g., CPU and/or GPU servers in data centers, cloud computing, edge computing, and the like). In other instances, modifications to power supply and/or power consumption results in changes to creation of heat by components.

### BRIEF DESCRIPTION OF THE DRAWINGS

FIG. 1 illustrates one or more example environments in which teachings of this disclosure may be implemented.

FIG. 2 illustrates at least one example of a data center for executing workloads with disaggregated resources.

FIG. 3 illustrates at least one example of a pod that may be included in the data center of FIG. 2.

FIG. 4 is a perspective view of at least one example of a rack that may be included in the pod of FIG. 3.

FIG. 5 is a side elevation view of the rack of FIG. 4.

FIG. 6 is a perspective view of the rack of FIG. 4 having a sled mounted therein.

FIG. 7 is a is a block diagram of at least one example of a top side of the sled of FIG. 6.

FIG. 8 is a block diagram of at least one example of a bottom side of the sled of FIG. 7.

FIG. 9 is a block diagram of at least one example of a compute sled usable in the data center of FIG. 2.

FIG. 10 is a top perspective view of at least one example of the compute sled of FIG. 9.

FIG. 11 is a block diagram of at least one example of an accelerator sled usable in the data center of FIG. 2.

FIG. 12 is a top perspective view of at least one example of the accelerator sled of FIG. 10.

FIG. 13 is a block diagram of at least one example of a storage sled usable in the data center of FIG. 2.

FIG. 14 is a top perspective view of at least one example of the storage sled of FIG. 13.

FIG. 15 is a block diagram of at least one example of a memory sled usable in the data center of FIG. 2.

FIG. 16 is a block diagram of a system that may be established within the data center of FIG. 2 to execute workloads with managed nodes of disaggregated resources.

FIG. 17 illustrates an example apparatus or system including example power and cooling distribution circuitry and example resource prediction circuitry to orchestrate power and cooling of compute components to satisfy service level agreements.

FIG. 18 is a block diagram of an example of the power and cooling distribution circuitry of FIG. 17.

FIG. 19 is a block diagram of an example of the resource prediction circuitry of FIG. 17.

FIG. 20 is a flowchart representative of example machine readable instructions and/or example operations that may be executed, instantiated, and/or performed by example programmable circuitry to implement the example power and cooling distribution circuitry of FIGS. 17 and 18.

FIG. 21 is a flowchart representative of example machine readable instructions and/or example operations that may be executed, instantiated, and/or performed by example programmable circuitry to implement the example resource prediction circuitry of FIGS. 17 and 19.

FIG. 22 is a block diagram of an example processing platform including programmable circuitry structured to execute, instantiate, and/or perform the example machine readable instructions and/or perform the example operations of FIGS. 20 and 21 to implement the circuitry of the example system of FIG. 17.

FIG. 23 is a block diagram of an example implementation of the programmable circuitry of FIG. 22.

FIG. 24 is a block diagram of another example implementation of the programmable circuitry of FIG. 22.

In general, the same reference numbers will be used throughout the drawing(s) and accompanying written description to refer to the same or like parts. The figures are not to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

### DETAILED DESCRIPTION

The use of liquids to cool electronic components is being explored for its benefits over more traditional air-cooling systems, as there are increasing needs to address thermal management risks resulting from increased thermal design power in high performance systems (e.g., CPU and/or GPU servers in data centers, accelerators, artificial intelligence computing, machine learning computing, cloud computing, edge computing, and the like). More particularly, relative to air, liquid has inherent advantages of higher specific heat (when no boiling is involved) and higher latent heat of vaporization (when boiling is involved). In some instances, liquid can be used to indirectly cool electronic components by cooling a cold plate that is thermally coupled to the electronic component(s). An alternative approach is to directly immerse electronic components in the cooling liquid. In direct immersion cooling, the liquid can be in direct contact with the electronic components to directly draw away heat from the electronic components. To enable the cooling liquid to be in direct contact with electronic components, the cooling liquid is electrically insulative (e.g., a dielectric liquid).

A liquid cooling system can involve at least one of single-phase cooling or two-phase cooling. As used herein, single-phase cooling (e.g., single-phase immersion cooling) means the cooling fluid (sometimes also referred to herein as cooling liquid or coolant) used to cool electronic components draws heat away from heat sources (e.g., electronic components) without changing phase (e.g., without boiling and becoming vapor). Such cooling fluids are referred to herein as single-phase cooling fluids, liquids, or coolants. By contrast, as used herein, two-phase cooling (e.g., two-phase immersion cooling) means the cooling fluid (in this case, a cooling liquid) vaporizes or boils from the heat generated by the electronic components to be cooled, thereby changing from the liquid phase to the vapor phase. The gaseous vapor may subsequently be condensed back into a liquid (e.g., via a condenser) to again be used in the cooling process. Such cooling fluids are referred to herein as two-phase cooling fluids, liquids, or coolants. Notably, gases (e.g., air) can also be used to cool components and, therefore, may also be referred to as a cooling fluid and/or a coolant. However, indirect cooling and immersion cooling typically involves at least one cooling liquid (which may or may not change to the vapor phase when in use).

As cooling technologies become increasingly complex, cooling control systems have begun to consider variable cooling characteristics. Some cooling control systems include considerations for changes in cooling requirements of elements and/or devices of a given platform. Such cooling control systems may increase or decrease an amount of coolant supplied to the elements and/or devices based on service level agreements (SLAs) and/or service level objectives (SLOs).

SLAs are agreements between computing service providers and user devices. SLAs are associated with performance of workloads using compute services. SLAs define amounts of resources expected to be used for preforming a workload. For example, an SLA may define a number of compute cores, a type of computing unit (e.g., central processing unit, graphical processing unit, etc.), a performance characteristic of computing resources, etc.

SLOs are objectives a computing service provider must achieve to satisfy SLAs and/or continue operating compute resources. Some SLOs are specific to SLAs of a workload, such as meeting a frames per second objective. Other SLOs are specific to compute resources, such as minimum power supply, maximum power supply, cooling thresholds, power thresholds, etc.

Some cooling control systems utilize cooling terms of SLAs and/or SLOs to budget cooling resources. Budgeting cooling resources allows cooling control systems to accelerate and/or post-pone performance of certain workloads to increase cooling efficiency. Cooling budgets may include considerations for present and future energy consumption, performance costs, etc. When generating a cooling budget, some cooling control systems consider tolerating less efficient power dissipation based on cooling terms, cooling costs, and/or energy costs. As cooling technologies become increasingly complex, incentives to create control systems for relatively complex cooling systems continue to increase.

Example systems, apparatus, and methods to improve cooling systems and/or associated cooling processes are disclosed herein. In particular, disclosed herein are example systems, apparatus, and methods to balance and coordinate power and cooling systems for compute components using prediction circuitry and distribution circuitry. In some disclosed examples, power and cooling distribution circuitry orchestrates cooling resources and power resources to efficiently meet cooling terms and performance terms of SLAs. The power and cooling distribution circuitry generates one or more resource budgets that consider varying cooling resources and/or varying power resources. The power and cooling distribution circuitry utilizes prediction circuitry to modifies (e.g., compensate, adjust) SLA terms to account for variations in cooling resources and/or power resources. The prediction circuitry uses historical resource usage data and/or historical ambient temperature measurements to budget cooling resources and/or power resources.

In some examples, the power and cooling distribution circuitry generates a cooling budget based on accessible cooling resources and resource usage predictions. The cooling budget specifies allocation of cooling resources at a given time. Cooling controller circuitry configures usage of cooling resources as allocated by the power and cooling distribution circuitry.

In some examples disclosed herein, the power and cooling distribution circuitry generates a power budget based on the accessible power resources and resource usage predictions. The power budget specifies allocation of power resources at a given time. Power controller circuitry configures usage of power resources as allocated by the power and cooling distribution circuitry.

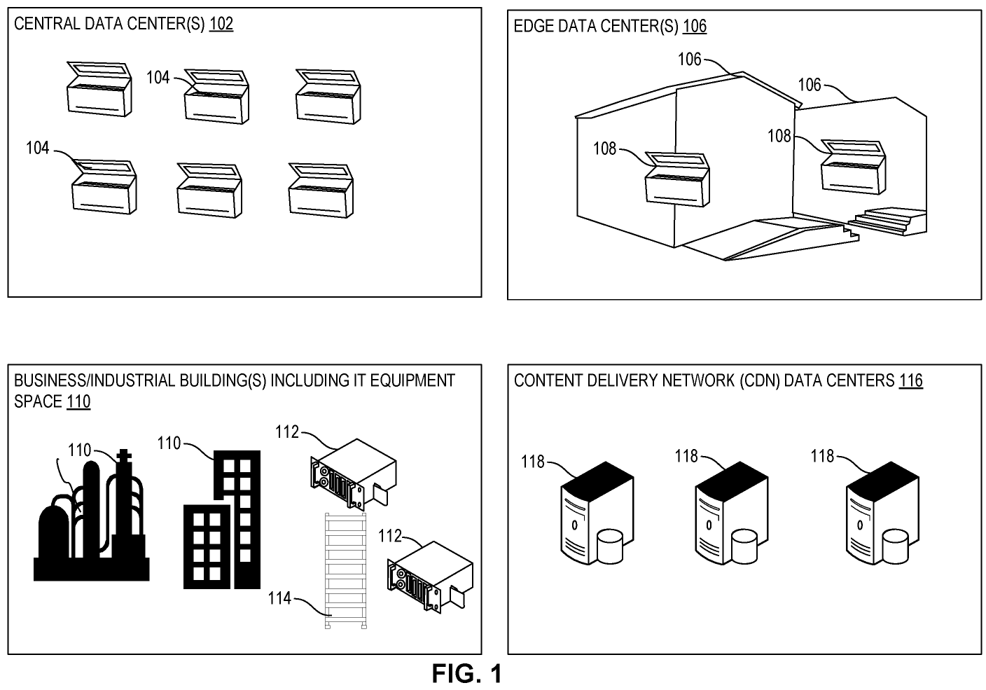

FIG. 1 illustrates one or more example environments in which teachings of this disclosure may be implemented. The example environment(s) of FIG. 1 can include one or more central data centers 102. The central data center(s) 102 can store a large number of servers used by, for instance, one or more organizations for data processing, storage, etc. As illustrated in FIG. 1, the central data center(s) 102 include a plurality of immersion tank(s) 104 to facilitate cooling of the servers and/or other electronic components stored at the central data center(s) 102. The immersion tank(s) 104 can provide for single-phase cooling or two-phase cooling.

The example environments of FIG. 1 can be part of an edge computing system. For instance, the example environments of FIG. 1 can include edge data centers or micro-data centers 106. The edge data center(s) 106 can include, for example, data centers located at a base of a cell tower. In some examples, the edge data center(s) 106 are located at or near a top of a cell tower and/or other utility pole. The edge data center(s) 106 include respective housings that store server(s), where the server(s) can be in communication with, for instance, the server(s) stored at the central data center(s) 102, client devices, and/or other computing devices in the edge network. Example housings of the edge data center(s) 106 may include materials that form one or more exterior surfaces that partially or fully protect contents therein, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. As illustrated in FIG. 1, the edge data center(s) 106 can include immersion tank(s) 108 to store server(s) and/or other electronic component(s) located at the edge data center(s) 106.

The example environment(s) of FIG. 1 can include buildings 110 for purposes of business and/or industry that store information technology (IT) equipment in, for example, one or more rooms of the building(s) 110. For example, as represented in FIG. 1, server(s) 112 can be stored with server rack(s) 114 that support the server(s) 112 (e.g., in an opening of slot of the rack 114). In some examples, the server(s) 112 located at the buildings 110 include on-premises server(s) of an edge computing network, where the on-premises server(s) are in communication with remote server(s) (e.g., the server(s) at the edge data center(s) 106) and/or other computing device(s) within an edge network.

The example environment(s) of FIG. 1 include content delivery network (CDN) data center(s) 116. The CDN data center(s) 116 of this example include server(s) 118 that cache content such as images, webpages, videos, etc. accessed via user devices. The server(s) 118 of the CDN data centers 116 can be disposed in immersion cooling tank(s) such as the immersion tanks 104, 108 shown in connection with the data centers 102, 106.

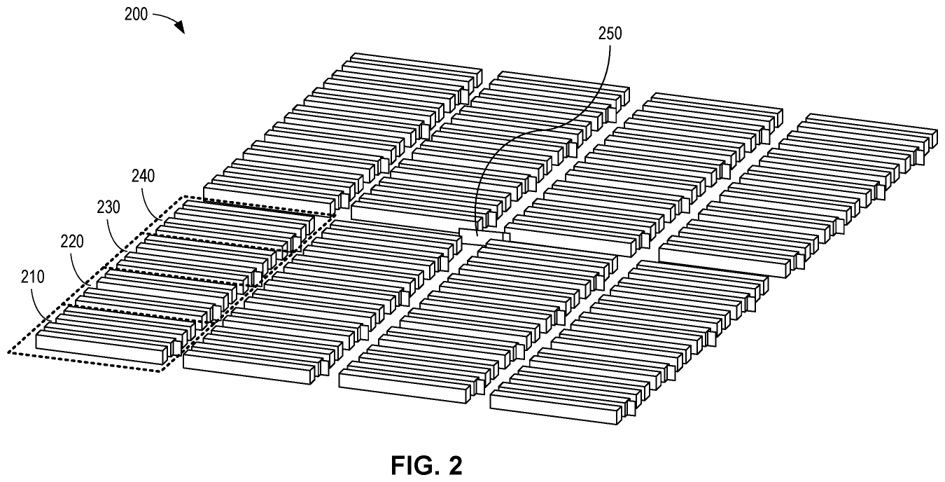

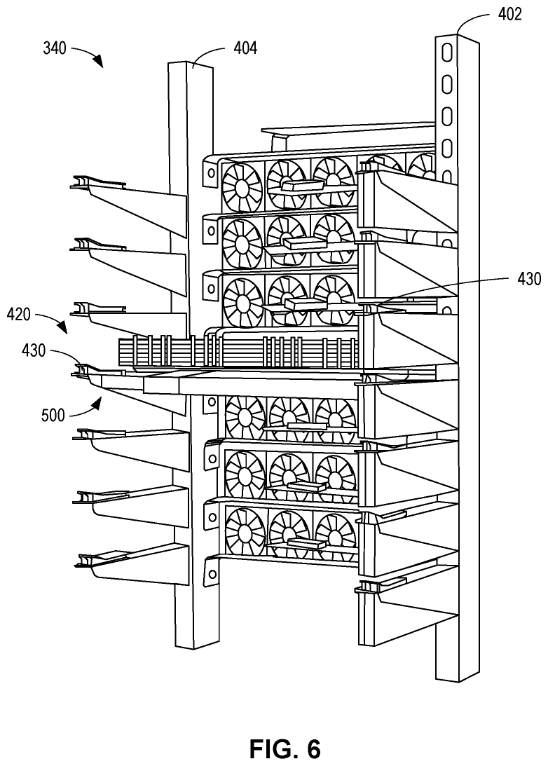

In some instances, the example data centers 102, 106, 116 and/or building(s) 110 of FIG. 1 include servers and/or other electronic components that are cooled independent of immersion tanks (e.g., the immersion tanks 104, 108) and/or an associated immersion cooling system. That is, in some examples, some or all of the servers and/or other electronic components in the data centers 102, 106, 116 and/or building(s) 110 can be cooled by air and/or liquid coolants without immersing the servers and/or other electronic components therein. Thus, in some examples, the immersion tanks 104, 108 of FIG. 1 may be omitted. Further, the example data centers 102, 106, 116 and/or building(s) 110 of FIG. 1 can correspond to, be implemented by, and/or be adaptations of the example data center 210 described in further detail below in connection with FIGS. 2-16.

Although a certain number of cooling tank(s) and other component(s) are shown in the figures, any number of such components may be present. Also, the example cooling data centers and/or other structures or environments disclosed herein are not limited to arrangements of the size that are depicted in FIG. 1. For instance, the structures containing example cooling systems and/or components thereof disclosed herein can be of a size that includes an opening to accommodate service personnel, such as the example data center(s) 106 of FIG. 1, but can also be smaller (e.g., a “doghouse” enclosure). For instance, the structures containing example cooling systems and/or components thereof disclosed herein can be sized such that access (e.g., the only access) to an interior of the structure is a port for service personnel to reach into the structure. In some examples, the structures containing example cooling systems and/or components thereof disclosed herein are be sized such that only a tool can reach into the enclosure because the structure may be supported by, for a utility pole or radio tower, or a larger structure.

FIG. 2 illustrates an example data center 210 in which disaggregated resources may cooperatively execute one or more workloads (e.g., applications on behalf of customers). The illustrated data center 210 includes multiple platforms 210, 220, 230, 240 (referred to herein as pods), each of which includes one or more rows of racks. Although the data center 210 is shown with multiple pods, in some examples, the data center 210 may be implemented as a single pod. As described in more detail herein, a rack may house multiple sleds. A sled may be primarily equipped with a particular type of resource (e.g., memory devices, data storage devices, accelerator devices, general purpose processors), i.e., resources that can be logically coupled to form a composed node. Some such nodes may act as, for example, a server. In the illustrative example, the sleds in the pods 210, 220, 230, 240 are connected to multiple pod switches (e.g., switches that route data communications to and from sleds within the pod). The pod switches, in turn, connect with spine switches 250 that switch communications among pods (e.g., the pods 210, 220, 230, 240) in the data center 210. In some examples, the sleds may be connected with a fabric using Intel Omni-Path™ technology. In other examples, the sleds may be connected with other fabrics, such as InfiniBand or Ethernet. As described in more detail herein, resources within the sleds in the data center 210 may be allocated to a group (referred to herein as a “managed node”) containing resources from one or more sleds to be collectively utilized in the execution of a workload. The workload can execute as if the resources belonging to the managed node were located on the same sled. The resources in a managed node may belong to sleds belonging to different racks, and even to different pods 210, 220, 230, 240. As such, some resources of a single sled may be allocated to one managed node while other resources of the same sled are allocated to a different managed node (e.g., first programmable circuitry assigned to one managed node and second programmable circuitry of the same sled assigned to a different managed node).

A data center including disaggregated resources, such as the data center 210, can be used in a wide variety of contexts, such as enterprise, government, cloud service provider, and communications service provider (e.g., Telco's), as well in a wide variety of sizes, from cloud service provider mega-data centers that consume over 210,000 sq. ft. to single- or multi-rack installations for use in base stations.

In some examples, the disaggregation of resources is accomplished by using individual sleds that include predominantly a single type of resource (e.g., compute sleds including primarily compute resources, memory sleds including primarily memory resources). The disaggregation of resources in this manner, and the selective allocation and deallocation of the disaggregated resources to form a managed node assigned to execute a workload, improves the operation and resource usage of the data center 210 relative to typical data centers. Such typical data centers include hyperconverged servers containing compute, memory, storage and perhaps additional resources in a single chassis. For example, because a given sled will contain mostly resources of a same particular type, resources of that type can be upgraded independently of other resources. Additionally, because different resource types (processors, storage, accelerators, etc.) typically have different refresh rates, greater resource utilization and reduced total cost of ownership may be achieved. For example, a data center operator can upgrade the programmable circuitry throughout a facility by only swapping out the compute sleds. In such a case, accelerator and storage resources may not be contemporaneously upgraded and, rather, may be allowed to continue operating until those resources are scheduled for their own refresh. Resource utilization may also increase. For example, if managed nodes are composed based on requirements of the workloads that will be running on them, resources within a node are more likely to be fully utilized. Such utilization may allow for more managed nodes to run in a data center with a given set of resources, or for a data center expected to run a given set of workloads, to be built using fewer resources.

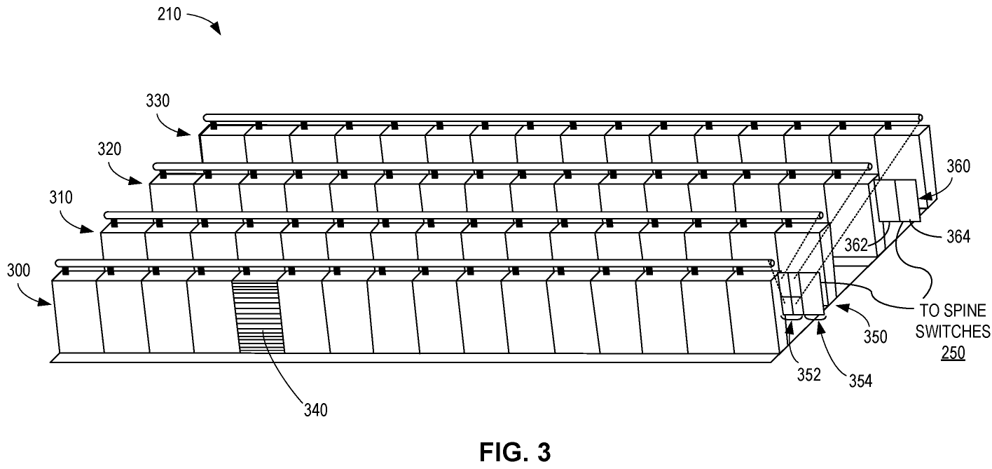

Referring now to FIG. 3, the pod 210, in the illustrative example, includes a set of rows 300, 310, 320, 330 of racks 340. Individual ones of the racks 340 may house multiple sleds (e.g., sixteen sleds) and provide power and data connections to the housed sleds, as described in more detail herein. In the illustrative example, the racks are connected to multiple pod switches 350, 360. The pod switch 350 includes a set of ports 352 to which the sleds of the racks of the pod 210 are connected and another set of ports 354 that connect the pod 210 to the spine switches 250 to provide connectivity to other pods in the data center 210. Similarly, the pod switch 360 includes a set of ports 362 to which the sleds of the racks of the pod 210 are connected and a set of ports 364 that connect the pod 210 to the spine switches 250. As such, the use of the pair of switches 350, 360 provides an amount of redundancy to the pod 210. For example, if either of the switches 350, 360 fails, the sleds in the pod 210 may still maintain data communication with the remainder of the data center 210 (e.g., sleds of other pods) through the other switch 350, 360. Furthermore, in the illustrative example, the switches 250, 350, 360 may be implemented as dual-mode optical switches, capable of routing both Ethernet protocol communications carrying Internet Protocol (IP) packets and communications according to a second, high-performance link-layer protocol (e.g., PCI Express) via optical signaling media of an optical fabric.

It should be appreciated that any one of the other pods 220, 230, 240 (as well as any additional pods of the data center 210) may be similarly structured as, and have components similar to, the pod 210 shown in and disclosed in regard to FIG. 3 (e.g., a given pod may have rows of racks housing multiple sleds as described above). Additionally, while two pod switches 350, 360 are shown, it should be understood that in other examples, a different number of pod switches may be present, providing even more failover capacity. In other examples, pods may be arranged differently than the rows-of-racks configuration shown in FIGS. 2 and 3. For example, a pod may include multiple sets of racks arranged radially, i.e., the racks are equidistant from a center switch.

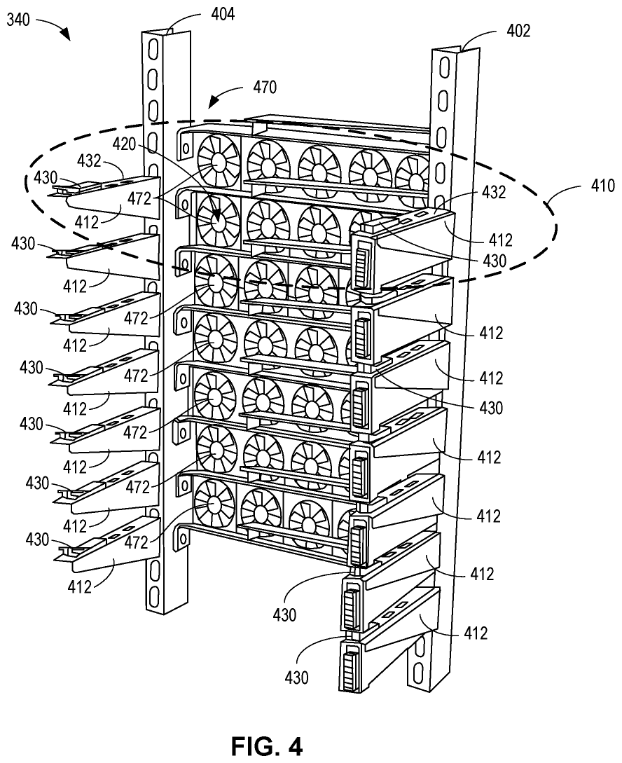

FIGS. 4-6 illustrate an example rack 340 of the data center 210. As shown in the illustrated example, the rack 340 includes two elongated support posts 402, 404, which are arranged vertically. For example, the elongated support posts 402, 404 may extend upwardly from a floor of the data center 210 when deployed. The rack 340 also includes one or more horizontal pairs 410 of elongated support arms 412 (identified in FIG. 4 via a dashed ellipse) configured to support a sled of the data center 210 as discussed below. One elongated support arm 412 of the pair of elongated support arms 412 extends outwardly from the elongated support post 402 and the other elongated support arm 412 extends outwardly from the elongated support post 404.

In the illustrative examples, at least some of the sleds of the data center 210 are chassis-less sleds. That is, such sleds have a chassis-less circuit board substrate on which physical resources (e.g., processors, memory, accelerators, storage, etc.) are mounted as discussed in more detail below. As such, the rack 340 is configured to receive the chassis-less sleds. For example, a given pair 410 of the elongated support arms 412 defines a sled slot 420 of the rack 340, which is configured to receive a corresponding chassis-less sled. To do so, the elongated support arms 412 include corresponding circuit board guides 430 configured to receive the chassis-less circuit board substrate of the sled. The circuit board guides 430 are secured to, or otherwise mounted to, a top side 432 of the corresponding elongated support arms 412. For example, in the illustrative example, the circuit board guides 430 are mounted at a distal end of the corresponding elongated support arm 412 relative to the corresponding elongated support post 402, 404. For clarity of FIGS. 4-6, not every circuit board guide 430 may be referenced in each figure. In some examples, at least some of the sleds include a chassis and the racks 340 are suitably adapted to receive the chassis.

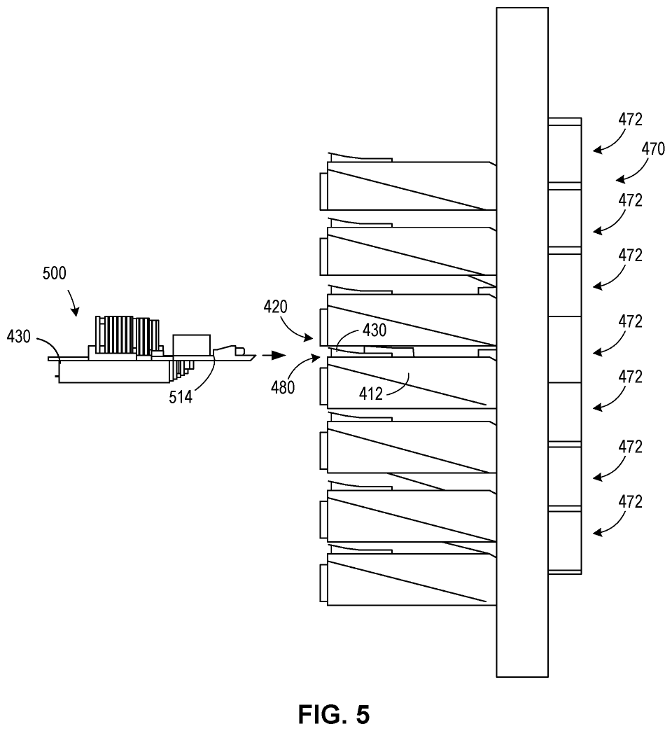

The circuit board guides 430 include an inner wall that defines a circuit board slot 480 configured to receive the chassis-less circuit board substrate of a sled 500 when the sled 500 is received in the corresponding sled slot 420 of the rack 340. To do so, as shown in FIG. 5, a user (or robot) aligns the chassis-less circuit board substrate of an illustrative chassis-less sled 500 to a sled slot 420. The user, or robot, may then slide the chassis-less circuit board substrate forward into the sled slot 420 such that each side edge 514 of the chassis-less circuit board substrate is received in a corresponding circuit board slot 480 of the circuit board guides 430 of the pair 410 of elongated support arms 412 that define the corresponding sled slot 420 as shown in FIG. 5. By having robotically accessible and robotically manipulable sleds including disaggregated resources, the different types of resource can be upgraded independently of one other and at their own optimized refresh rate. Furthermore, the sleds are configured to blindly mate with power and data communication cables in the rack 340, enhancing their ability to be quickly removed, upgraded, reinstalled, and/or replaced. As such, in some examples, the data center 210 may operate (e.g., execute workloads, undergo maintenance and/or upgrades, etc.) without human involvement on the data center floor. In other examples, a human may facilitate one or more maintenance or upgrade operations in the data center 210.

It should be appreciated that the circuit board guides 430 are dual sided. That is, a circuit board guide 430 includes an inner wall that defines a circuit board slot 480 on each side of the circuit board guide 430. In this way, the circuit board guide 430 can support a chassis-less circuit board substrate on either side. As such, a single additional elongated support post may be added to the rack 340 to turn the rack 340 into a two-rack solution that can hold twice as many sled slots 420 as shown in FIG. 4. The illustrative rack 340 includes seven pairs 410 of elongated support arms 412 that define seven corresponding sled slots 420. The sled slots 420 are configured to receive and support a corresponding sled 500 as discussed above. In other examples, the rack 340 may include additional or fewer pairs 410 of elongated support arms 412 (i.e., additional or fewer sled slots 420). It should be appreciated that because the sled 500 is chassis-less, the sled 500 may have an overall height that is different than typical servers. As such, in some examples, the height of a given sled slot 420 may be shorter than the height of a typical server (e.g., shorter than a single rank unit, referred to as “1U”). That is, the vertical distance between pairs 410 of elongated support arms 412 may be less than a standard rack unit “1U.” Additionally, due to the relative decrease in height of the sled slots 420, the overall height of the rack 340 in some examples may be shorter than the height of traditional rack enclosures. For example, in some examples, the elongated support posts 402, 404 may have a length of six feet or less. Again, in other examples, the rack 340 may have different dimensions. For example, in some examples, the vertical distance between pairs 410 of elongated support arms 412 may be greater than a standard rack unit “1U”. In such examples, the increased vertical distance between the sleds allows for larger heatsinks to be attached to the physical resources and for larger fans to be used (e.g., in the fan array 470 described below) for cooling the sleds, which in turn can allow the physical resources to operate at increased power levels. Further, it should be appreciated that the rack 340 does not include any walls, enclosures, or the like. Rather, the rack 340 is an enclosure-less rack that is opened to the local environment. In some cases, an end plate may be attached to one of the elongated support posts 402, 404 in those situations in which the rack 340 forms an end-of-row rack in the data center 210.

In some examples, various interconnects may be routed upwardly or downwardly through the elongated support posts 402, 404. To facilitate such routing, the elongated support posts 402, 404 include an inner wall that defines an inner chamber in which interconnects may be located. The interconnects routed through the elongated support posts 402, 404 may be implemented as any type of interconnects including, but not limited to, data or communication interconnects to provide communication connections to the sled slots 420, power interconnects to provide power to the sled slots 420, and/or other types of interconnects.

The rack 340, in the illustrative example, includes a support platform on which a corresponding optical data connector (not shown) is mounted. Such optical data connectors are associated with corresponding sled slots 420 and are configured to mate with optical data connectors of corresponding sleds 500 when the sleds 500 are received in the corresponding sled slots 420. In some examples, optical connections between components (e.g., sleds, racks, and switches) in the data center 210 are made with a blind mate optical connection. For example, a door on a given cable may prevent dust from contaminating the fiber inside the cable. In the process of connecting to a blind mate optical connector mechanism, the door is pushed open when the end of the cable approaches or enters the connector mechanism. Subsequently, the optical fiber inside the cable may enter a gel within the connector mechanism and the optical fiber of one cable comes into contact with the optical fiber of another cable within the gel inside the connector mechanism.

The illustrative rack 340 also includes a fan array 470 coupled to the cross-support arms of the rack 340. The fan array 470 includes one or more rows of cooling fans 472, which are aligned in a horizontal line between the elongated support posts 402, 404. In the illustrative example, the fan array 470 includes a row of cooling fans 472 for the different sled slots 420 of the rack 340. As discussed above, the sleds 500 do not include any on-board cooling system in the illustrative example and, as such, the fan array 470 provides cooling for such sleds 500 received in the rack 340. In other examples, some or all of the sleds 500 can include on-board cooling systems. Further, in some examples, the sleds 500 and/or the racks 340 may include and/or incorporate a liquid and/or immersion cooling system to facilitate cooling of electronic component(s) on the sleds 500. The rack 340, in the illustrative example, also includes different power supplies associated with different ones of the sled slots 420. A given power supply is secured to one of the elongated support arms 412 of the pair 410 of elongated support arms 412 that define the corresponding sled slot 420. For example, the rack 340 may include a power supply coupled or secured to individual ones of the elongated support arms 412 extending from the elongated support post 402. A given power supply includes a power connector configured to mate with a power connector of a sled 500 when the sled 500 is received in the corresponding sled slot 420. In the illustrative example, the sled 500 does not include any on-board power supply and, as such, the power supplies provided in the rack 340 supply power to corresponding sleds 500 when mounted to the rack 340. A given power supply is configured to satisfy the power requirements for its associated sled, which can differ from sled to sled. Additionally, the power supplies provided in the rack 340 can operate independent of each other. That is, within a single rack, a first power supply providing power to a compute sled can provide power levels that are different than power levels supplied by a second power supply providing power to an accelerator sled. The power supplies may be controllable at the sled level or rack level, and may be controlled locally by components on the associated sled or remotely, such as by another sled or an orchestrator.

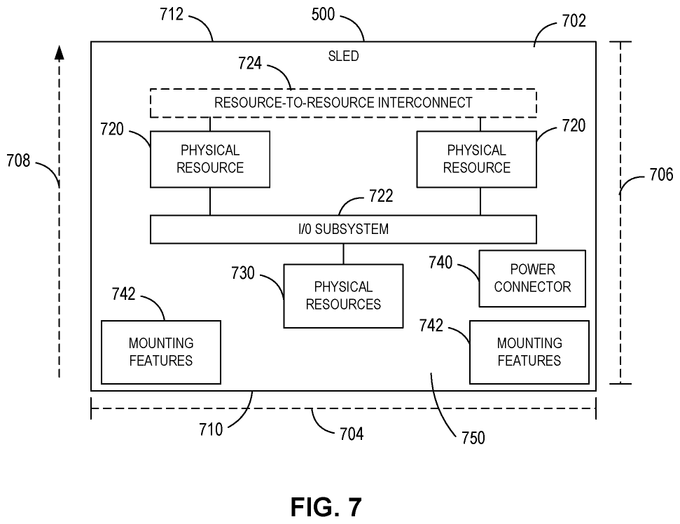

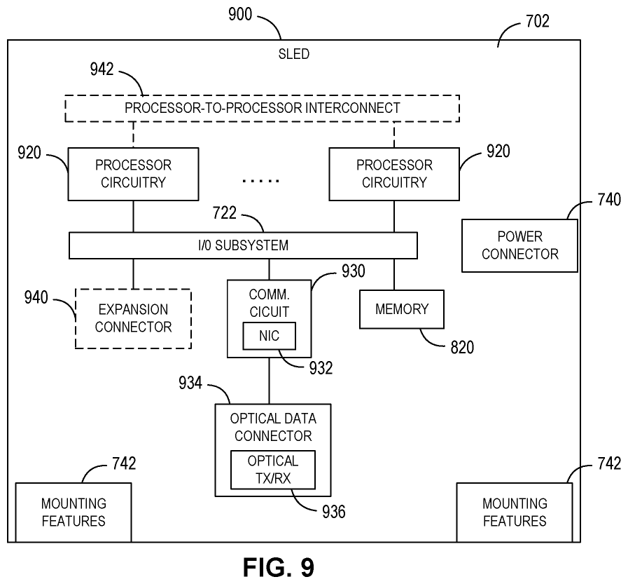

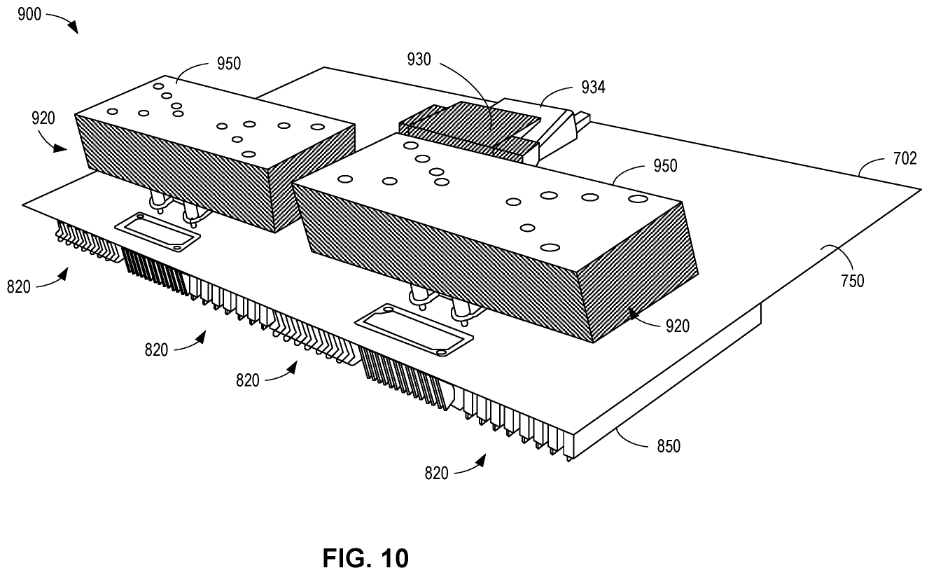

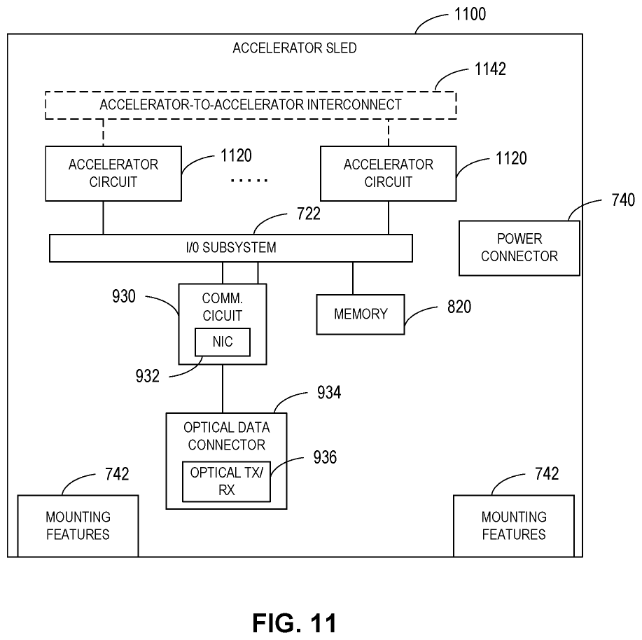

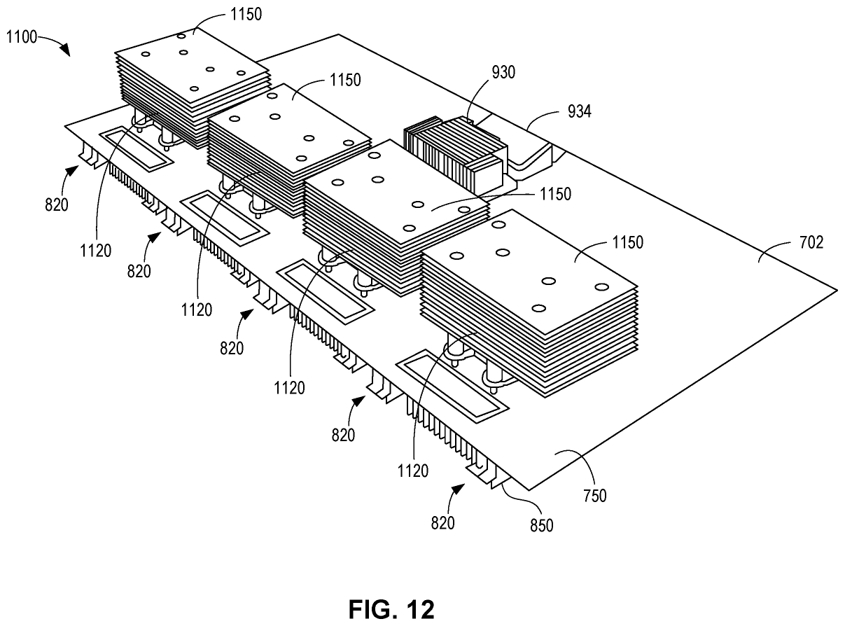

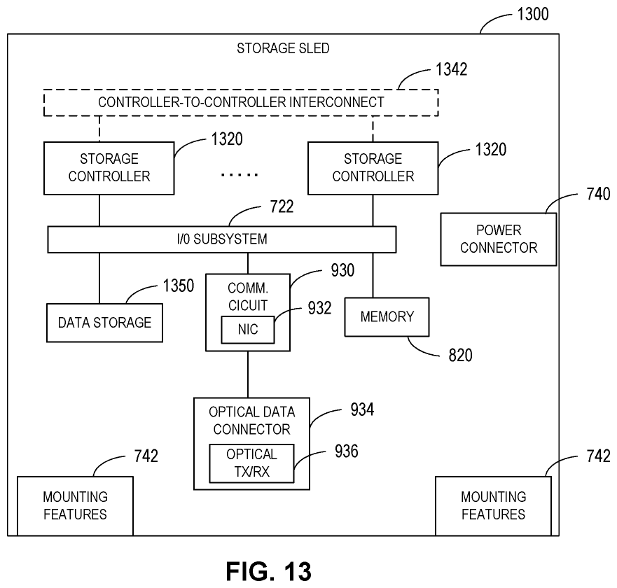

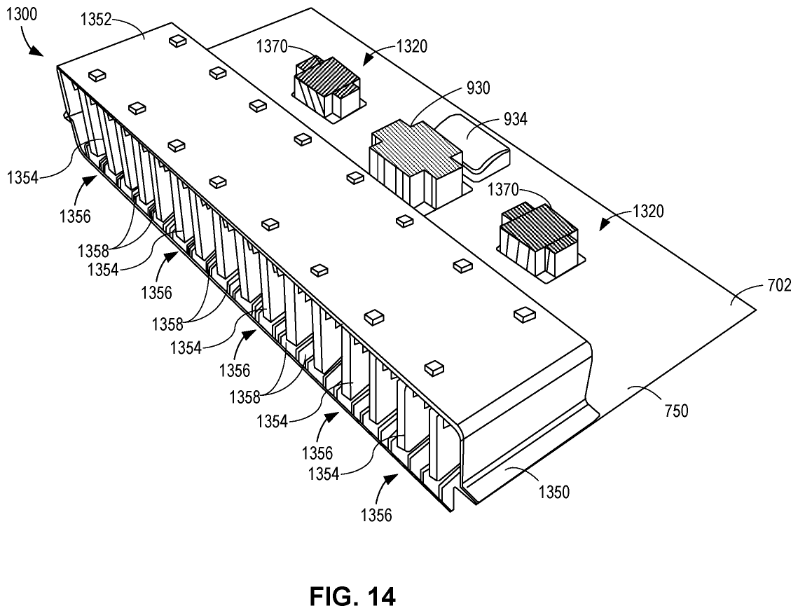

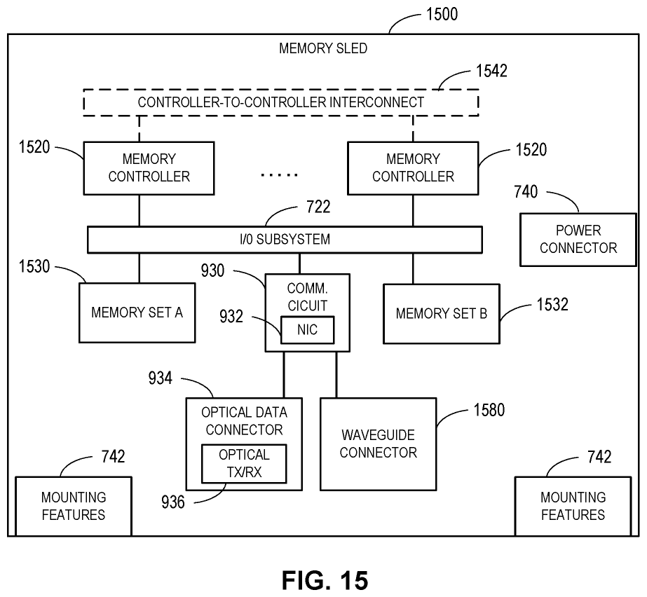

Referring now to FIG. 7, the sled 500, in the illustrative example, is configured to be mounted in a corresponding rack 340 of the data center 210 as discussed above. In some examples, a give sled 500 may be optimized or otherwise configured for performing particular tasks, such as compute tasks, acceleration tasks, data storage tasks, etc. For example, the sled 500 may be implemented as a compute sled 900 as discussed below in regard to FIGS. 9 and 10, an accelerator sled 1100 as discussed below in regard to FIGS. 11 and 12, a storage sled 1300 as discussed below in regard to FIGS. 13 and 14, or as a sled optimized or otherwise configured to perform other specialized tasks, such as a memory sled 1500, discussed below in regard to FIG. 15.

As discussed above, the illustrative sled 500 includes a chassis-less circuit board substrate 702, which supports various physical resources (e.g., electrical components) mounted thereon. It should be appreciated that the circuit board substrate 702 is “chassis-less” in that the sled 500 does not include a housing or enclosure. Rather, the chassis-less circuit board substrate 702 is open to the local environment. The chassis-less circuit board substrate 702 may be formed from any material capable of supporting the various electrical components mounted thereon. For example, in an illustrative example, the chassis-less circuit board substrate 702 is formed from an FR-4 glass-reinforced epoxy laminate material. Other materials may be used to form the chassis-less circuit board substrate 702 in other examples.

As discussed in more detail below, the chassis-less circuit board substrate 702 includes multiple features that improve the thermal cooling characteristics of the various electrical components mounted on the chassis-less circuit board substrate 702. As discussed, the chassis-less circuit board substrate 702 does not include a housing or enclosure, which may improve the airflow over the electrical components of the sled 500 by reducing those structures that may inhibit air flow. For example, because the chassis-less circuit board substrate 702 is not positioned in an individual housing or enclosure, there is no vertically arranged backplane (e.g., a back plate of the chassis) attached to the chassis-less circuit board substrate 702, which could inhibit air flow across the electrical components. Additionally, the chassis-less circuit board substrate 702 has a geometric shape configured to reduce the length of the airflow path across the electrical components mounted to the chassis-less circuit board substrate 702. For example, the illustrative chassis-less circuit board substrate 702 has a width 704 that is greater than a depth 706 of the chassis-less circuit board substrate 702. In one particular example, the chassis-less circuit board substrate 702 has a width of about 21 inches and a depth of about 9 inches, compared to a typical server that has a width of about 17 inches and a depth of about 39 inches. As such, an airflow path 708 that extends from a front edge 710 of the chassis-less circuit board substrate 702 toward a rear edge 712 has a shorter distance relative to typical servers, which may improve the thermal cooling characteristics of the sled 500. Furthermore, although not illustrated in FIG. 7, the various physical resources mounted to the chassis-less circuit board substrate 702 in this example are mounted in corresponding locations such that no two substantively heat-producing electrical components shadow each other as discussed in more detail below. That is, no two electrical components, which produce appreciable heat during operation (i.e., greater than a nominal heat sufficient enough to adversely impact the cooling of another electrical component), are mounted to the chassis-less circuit board substrate 702 linearly in-line with each other along the direction of the airflow path 708 (i.e., along a direction extending from the front edge 710 toward the rear edge 712 of the chassis-less circuit board substrate 702). The placement and/or structure of the features may be suitable adapted when the electrical component(s) are being cooled via liquid (e.g., one phase or two-phase cooling).

As discussed above, the illustrative sled 500 includes one or more physical resources 720 mounted to a top side 750 of the chassis-less circuit board substrate 702. Although two physical resources 720 are shown in FIG. 7, it should be appreciated that the sled 500 may include one, two, or more physical resources 720 in other examples. The physical resources 720 may be implemented as any type of processor, controller, or other compute circuit capable of performing various tasks such as compute functions and/or controlling the functions of the sled 500 depending on, for example, the type or intended functionality of the sled 500. For example, as discussed in more detail below, the physical resources 720 may be implemented as high-performance processors in examples in which the sled 500 is implemented as a compute sled, as accelerator co-processors or circuits in examples in which the sled 500 is implemented as an accelerator sled, storage controllers in examples in which the sled 500 is implemented as a storage sled, or a set of memory devices in examples in which the sled 500 is implemented as a memory sled.

The sled 500 also includes one or more additional physical resources 730 mounted to the top side 750 of the chassis-less circuit board substrate 702. In the illustrative example, the additional physical resources include a network interface controller (NIC) as discussed in more detail below. Depending on the type and functionality of the sled 500, the physical resources 730 may include additional or other electrical components, circuits, and/or devices in other examples.

The physical resources 720 are communicatively coupled to the physical resources 730 via an input/output (I/O) subsystem 722. The I/O subsystem 722 may be implemented as circuitry and/or components to facilitate input/output operations with the physical resources 720, the physical resources 730, and/or other components of the sled 500. For example, the I/O subsystem 722 may be implemented as, or otherwise include, memory controller hubs, input/output control hubs, integrated sensor hubs, firmware devices, communication links (e.g., point-to-point links, bus links, wires, cables, waveguides, light guides, printed circuit board traces, etc.), and/or other components and subsystems to facilitate the input/output operations. In the illustrative example, the I/O subsystem 722 is implemented as, or otherwise includes, a double data rate 4 (DDR4) data bus or a DDR₅ data bus.

In some examples, the sled 500 may also include a resource-to-resource interconnect 724. The resource-to-resource interconnect 724 may be implemented as any type of communication interconnect capable of facilitating resource-to-resource communications. In the illustrative example, the resource-to-resource interconnect 724 is implemented as a high-speed point-to-point interconnect (e.g., faster than the I/O subsystem 722). For example, the resource-to-resource interconnect 724 may be implemented as a QuickPath Interconnect (QPI), an UltraPath Interconnect (UPI), or other high-speed point-to-point interconnect dedicated to resource-to-resource communications.

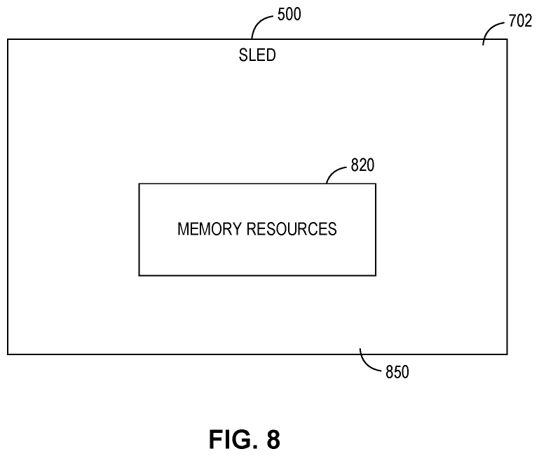

The sled 500 also includes a power connector 740 configured to mate with a corresponding power connector of the rack 340 when the sled 500 is mounted in the corresponding rack 340. The sled 500 receives power from a power supply of the rack 340 via the power connector 740 to supply power to the various electrical components of the sled 500. That is, the sled 500 does not include any local power supply (i.e., an on-board power supply) to provide power to the electrical components of the sled 500. The exclusion of a local or on-board power supply facilitates the reduction in the overall footprint of the chassis-less circuit board substrate 702, which may increase the thermal cooling characteristics of the various electrical components mounted on the chassis-less circuit board substrate 702 as discussed above. In some examples, voltage regulators are placed on a bottom side 850 (see FIG. 8) of the chassis-less circuit board substrate 702 directly opposite of programmable circuitry 920 (see FIG. 9), and power is routed from the voltage regulators to the programmable circuitry 920 by vias extending through the circuit board substrate 702. Such a configuration provides an increased thermal budget, additional current and/or voltage, and better voltage control relative to typical printed circuit boards in which processor power is delivered from a voltage regulator, in part, by printed circuit traces.

In some examples, the sled 500 may also include mounting features 742 configured to mate with a mounting arm, or other structure, of a robot to facilitate the placement of the sled 500 in a rack 340 by the robot. The mounting features 742 may be implemented as any type of physical structures that allow the robot to grasp the sled 500 without damaging the chassis-less circuit board substrate 702 or the electrical components mounted thereto. For example, in some examples, the mounting features 742 may be implemented as non-conductive pads attached to the chassis-less circuit board substrate 702. In other examples, the mounting features may be implemented as brackets, braces, or other similar structures attached to the chassis-less circuit board substrate 702. The particular number, shape, size, and/or make-up of the mounting feature 742 may depend on the design of the robot configured to manage the sled 500.

Referring now to FIG. 8, in addition to the physical resources 730 mounted on the top side 750 of the chassis-less circuit board substrate 702, the sled 500 also includes one or more memory devices 820 mounted to a bottom side 850 of the chassis-less circuit board substrate 702. That is, the chassis-less circuit board substrate 702 is implemented as a double-sided circuit board. The physical resources 720 are communicatively coupled to the memory devices 820 via the I/O subsystem 722. For example, the physical resources 720 and the memory devices 820 may be communicatively coupled by one or more vias extending through the chassis-less circuit board substrate 702. Different ones of the physical resources 720 may be communicatively coupled to different sets of one or more memory devices 820 in some examples. Alternatively, in other examples, different ones of the physical resources 720 may be communicatively coupled to the same ones of the memory devices 820.

The memory devices 820 may be implemented as any type of memory device capable of storing data for the physical resources 720 during operation of the sled 500, such as any type of volatile (e.g., dynamic random-access memory (DRAM), etc.) or non-volatile memory. Volatile memory may be a storage medium that requires power to maintain the state of data stored by the medium. Non-limiting examples of volatile memory may include various types of random-access memory (RAM), such as dynamic random-access memory (DRAM) or static random-access memory (SRAM). One particular type of DRAM that may be used in a memory module is synchronous dynamic random-access memory (SDRAM). In particular examples, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

In one example, the memory device is a block addressable memory device, such as those based on NAND or NOR technologies. A memory device may also include next-generation nonvolatile devices, such as Intel 3D XPoint™ memory or other byte addressable write-in-place nonvolatile memory devices. In one example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In some examples, the memory device may include a transistor-less stackable cross point architecture in which memory cells sit at the intersection of word lines and bit lines and are individually addressable and in which bit storage is based on a change in bulk resistance.

Referring now to FIG. 9, in some examples, the sled 500 may be implemented as a compute sled 900. The compute sled 900 is optimized, or otherwise configured, to perform compute tasks. As discussed above, the compute sled 900 may rely on other sleds, such as acceleration sleds and/or storage sleds, to perform such compute tasks. The compute sled 900 includes various physical resources (e.g., electrical components) similar to the physical resources of the sled 500, which have been identified in FIG. 9 using the same reference numbers. The description of such components provided above in regard to FIGS. 7 and 8 applies to the corresponding components of the compute sled 900 and is not repeated herein for clarity of the description of the compute sled 900.

In the illustrative compute sled 900, the physical resources 720 include programmable circuitry 920. Although only two blocks of programmable circuitry 920 are shown in FIG. 9, it should be appreciated that the compute sled 900 may include additional processor circuits 920 in other examples. Illustratively, the programmable circuitry 920 corresponds to high-performance processors 920 and may be configured to operate at a relatively high-power rating. Although the high-performance programmable circuitry 920 generates additional heat operating at power ratings greater than typical processors (which operate at around 155-230 W), the enhanced thermal cooling characteristics of the chassis-less circuit board substrate 702 discussed above facilitate the higher power operation. For example, in the illustrative example, the programmable circuitry 920 is configured to operate at a power rating of at least 250 W. In some examples, the programmable circuitry 920 may be configured to operate at a power rating of at least 350 W.

In some examples, the compute sled 900 may also include a processor-to-processor interconnect 942. Similar to the resource-to-resource interconnect 724 of the sled 500 discussed above, the processor-to-processor interconnect 942 may be implemented as any type of communication interconnect capable of facilitating processor-to-processor interconnect 942 communications. In the illustrative example, the processor-to-processor interconnect 942 is implemented as a high-speed point-to-point interconnect (e.g., faster than the I/O subsystem 722). For example, the processor-to-processor interconnect 942 may be implemented as a QuickPath Interconnect (QPI), an UltraPath Interconnect (UPI), or other high-speed point-to-point interconnect dedicated to processor-to-processor communications.

The compute sled 900 also includes a communication circuit 930. The illustrative communication circuit 930 includes a network interface controller (NIC) 932, which may also be referred to as a host fabric interface (HFI). The NIC 932 may be implemented as, or otherwise include, any type of integrated circuit, discrete circuits, controller chips, chipsets, add-in-boards, daughtercards, network interface cards, or other devices that may be used by the compute sled 900 to connect with another compute device (e.g., with other sleds 500). In some examples, the NIC 932 may be implemented as part of a system-on-a-chip (SoC) that includes one or more processors, or included on a multichip package that also contains one or more processors. In some examples, the NIC 932 may include a local processor (not shown) and/or a local memory (not shown) that are both local to the NIC 932. In such examples, the local processor of the NIC 932 may be capable of performing one or more of the functions of the programmable circuitry 920. Additionally or alternatively, in such examples, the local memory of the NIC 932 may be integrated into one or more components of the compute sled at the board level, socket level, chip level, and/or other levels.

The communication circuit 930 is communicatively coupled to an optical data connector 934. The optical data connector 934 is configured to mate with a corresponding optical data connector of the rack 340 when the compute sled 900 is mounted in the rack 340. Illustratively, the optical data connector 934 includes a plurality of optical fibers which lead from a mating surface of the optical data connector 934 to an optical transceiver 936. The optical transceiver 936 is configured to convert incoming optical signals from the rack-side optical data connector to electrical signals and to convert electrical signals to outgoing optical signals to the rack-side optical data connector. Although shown as forming part of the optical data connector 934 in the illustrative example, the optical transceiver 936 may form a portion of the communication circuit 930 in other examples.

In some examples, the compute sled 900 may also include an expansion connector 940. In such examples, the expansion connector 940 is configured to mate with a corresponding connector of an expansion chassis-less circuit board substrate to provide additional physical resources to the compute sled 900. The additional physical resources may be used, for example, by the programmable circuitry 920 during operation of the compute sled 900. The expansion chassis-less circuit board substrate may be substantially similar to the chassis-less circuit board substrate 702 discussed above and may include various electrical components mounted thereto. The particular electrical components mounted to the expansion chassis-less circuit board substrate may depend on the intended functionality of the expansion chassis-less circuit board substrate. For example, the expansion chassis-less circuit board substrate may provide additional compute resources, memory resources, and/or storage resources. As such, the additional physical resources of the expansion chassis-less circuit board substrate may include, but is not limited to, processors, memory devices, storage devices, and/or accelerator circuits including, for example, field programmable gate arrays (FPGA), application-specific integrated circuits (ASICs), security co-processors, graphics processing units (GPUs), machine learning circuits, or other specialized processors, controllers, devices, and/or circuits.

Referring now to FIG. 10, an illustrative example of the compute sled 900 is shown. As shown, the programmable circuitry 920, communication circuit 930, and optical data connector 934 are mounted to the top side 750 of the chassis-less circuit board substrate 702. Any suitable attachment or mounting technology may be used to mount the physical resources of the compute sled 900 to the chassis-less circuit board substrate 702. For example, the various physical resources may be mounted in corresponding sockets (e.g., a processor socket), holders, or brackets. In some cases, some of the electrical components may be directly mounted to the chassis-less circuit board substrate 702 via soldering or similar techniques.

As discussed above, the separate programmable circuitry 920 and the communication circuit 930 are mounted to the top side 750 of the chassis-less circuit board substrate 702 such that no two heat-producing, electrical components shadow each other. In the illustrative example, the programmable circuitry 920 and the communication circuit 930 are mounted in corresponding locations on the top side 750 of the chassis-less circuit board substrate 702 such that no two of those physical resources are linearly in-line with others along the direction of the airflow path 708. It should be appreciated that, although the optical data connector 934 is in-line with the communication circuit 930, the optical data connector 934 produces no or nominal heat during operation.

The memory devices 820 of the compute sled 900 are mounted to the bottom side 850 of the of the chassis-less circuit board substrate 702 as discussed above in regard to the sled 500. Although mounted to the bottom side 850, the memory devices 820 are communicatively coupled to the programmable circuitry 920 located on the top side 750 via the I/O subsystem 722. Because the chassis-less circuit board substrate 702 is implemented as a double-sided circuit board, the memory devices 820 and the programmable circuitry 920 may be communicatively coupled by one or more vias, connectors, or other mechanisms extending through the chassis-less circuit board substrate 702. Different programmable circuitry 920 (e.g., different processors) may be communicatively coupled to a different set of one or more memory devices 820 in some examples. Alternatively, in other examples, different programmable circuitry 920 (e.g., different processors) may be communicatively coupled to the same ones of the memory devices 820. In some examples, the memory devices 820 may be mounted to one or more memory mezzanines on the bottom side of the chassis-less circuit board substrate 702 and may interconnect with a corresponding programmable circuitry 920 through a ball-grid array.

Different programmable circuitry 920 (e.g., different processors) include and/or is associated with corresponding heatsinks 950 secured thereto. Due to the mounting of the memory devices 820 to the bottom side 850 of the chassis-less circuit board substrate 702 (as well as the vertical spacing of the sleds 500 in the corresponding rack 340), the top side 750 of the chassis-less circuit board substrate 702 includes additional “free” area or space that facilitates the use of heatsinks 950 having a larger size relative to traditional heatsinks used in typical servers. Additionally, due to the improved thermal cooling characteristics of the chassis-less circuit board substrate 702, none of the processor heatsinks 950 include cooling fans attached thereto. That is, the heatsinks 950 may be fan-less heatsinks. In some examples, the heatsinks 950 mounted atop the programmable circuitry 920 may overlap with the heatsink attached to the communication circuit 930 in the direction of the airflow path 708 due to their increased size, as illustratively suggested by FIG. 10.

Referring now to FIG. 11, in some examples, the sled 500 may be implemented as an accelerator sled 1100. The accelerator sled 1100 is configured, to perform specialized compute tasks, such as machine learning, encryption, hashing, or other computational-intensive task. In some examples, for example, a compute sled 900 may offload tasks to the accelerator sled 1100 during operation. The accelerator sled 1100 includes various components similar to components of the sled 500 and/or the compute sled 900, which have been identified in FIG. 11 using the same reference numbers. The description of such components provided above in regard to FIGS. 7, 8, and 9 apply to the corresponding components of the accelerator sled 1100 and is not repeated herein for clarity of the description of the accelerator sled 1100.

In the illustrative accelerator sled 1100, the physical resources 720 include accelerator circuits 1120. Although only two accelerator circuits 1120 are shown in FIG. 11, it should be appreciated that the accelerator sled 1100 may include additional accelerator circuits 1120 in other examples. For example, as shown in FIG. 12, the accelerator sled 1100 may include four accelerator circuits 1120. The accelerator circuits 1120 may be implemented as any type of processor, co-processor, compute circuit, or other device capable of performing compute or processing operations. For example, the accelerator circuits 1120 may be implemented as, for example, field programmable gate arrays (FPGA), application-specific integrated circuits (ASICs), security co-processors, graphics processing units (GPUs), neuromorphic processor units, quantum computers, machine learning circuits, or other specialized processors, controllers, devices, and/or circuits.

In some examples, the accelerator sled 1100 may also include an accelerator-to-accelerator interconnect 1142. Similar to the resource-to-resource interconnect 724 of the sled 700 discussed above, the accelerator-to-accelerator interconnect 1142 may be implemented as any type of communication interconnect capable of facilitating accelerator-to-accelerator communications. In the illustrative example, the accelerator-to-accelerator interconnect 1142 is implemented as a high-speed point-to-point interconnect (e.g., faster than the I/O subsystem 722). For example, the accelerator-to-accelerator interconnect 1142 may be implemented as a QuickPath Interconnect (QPI), an UltraPath Interconnect (UPI), or other high-speed point-to-point interconnect dedicated to processor-to-processor communications. In some examples, the accelerator circuits 1120 may be daisy-chained with a primary accelerator circuit 1120 connected to the NIC 932 and memory 820 through the I/O subsystem 722 and a secondary accelerator circuit 1120 connected to the NIC 932 and memory 820 through a primary accelerator circuit 1120.

Referring now to FIG. 12, an illustrative example of the accelerator sled 1100 is shown. As discussed above, the accelerator circuits 1120, the communication circuit 930, and the optical data connector 934 are mounted to the top side 750 of the chassis-less circuit board substrate 702. Again, the individual accelerator circuits 1120 and communication circuit 930 are mounted to the top side 750 of the chassis-less circuit board substrate 702 such that no two heat-producing, electrical components shadow each other as discussed above. The memory devices 820 of the accelerator sled 1100 are mounted to the bottom side 850 of the of the chassis-less circuit board substrate 702 as discussed above in regard to the sled 700. Although mounted to the bottom side 850, the memory devices 820 are communicatively coupled to the accelerator circuits 1120 located on the top side 750 via the I/O subsystem 722 (e.g., through vias). Further, the accelerator circuits 1120 may include and/or be associated with a heatsink 1150 that is larger than a traditional heatsink used in a server. As discussed above with reference to the heatsinks 950 of FIG. 9, the heatsinks 1150 may be larger than traditional heatsinks because of the “free” area provided by the memory resources 820 being located on the bottom side 850 of the chassis-less circuit board substrate 702 rather than on the top side 750.

Referring now to FIG. 13, in some examples, the sled 500 may be implemented as a storage sled 1300. The storage sled 1300 is configured, to store data in a data storage 1350 local to the storage sled 1300. For example, during operation, a compute sled 900 or an accelerator sled 1100 may store and retrieve data from the data storage 1350 of the storage sled 1300. The storage sled 1300 includes various components similar to components of the sled 500 and/or the compute sled 900, which have been identified in FIG. 13 using the same reference numbers. The description of such components provided above in regard to FIGS. 7, 8, and 9 apply to the corresponding components of the storage sled 1300 and is not repeated herein for clarity of the description of the storage sled 1300.

In the illustrative storage sled 1300, the physical resources 720 includes storage controllers 1320. Although only two storage controllers 1320 are shown in FIG. 13, it should be appreciated that the storage sled 1300 may include additional storage controllers 1320 in other examples. The storage controllers 1320 may be implemented as any type of processor, controller, or control circuit capable of controlling the storage and retrieval of data into the data storage 1350 based on requests received via the communication circuit 930. In the illustrative example, the storage controllers 1320 are implemented as relatively low-power processors or controllers. For example, in some examples, the storage controllers 1320 may be configured to operate at a power rating of about 75 watts.

In some examples, the storage sled 1300 may also include a controller-to-controller interconnect 1342. Similar to the resource-to-resource interconnect 724 of the sled 500 discussed above, the controller-to-controller interconnect 1342 may be implemented as any type of communication interconnect capable of facilitating controller-to-controller communications. In the illustrative example, the controller-to-controller interconnect 1342 is implemented as a high-speed point-to-point interconnect (e.g., faster than the I/O subsystem 722). For example, the controller-to-controller interconnect 1342 may be implemented as a QuickPath Interconnect (QPI), an UltraPath Interconnect (UPI), or other high-speed point-to-point interconnect dedicated to processor-to-processor communications.

Referring now to FIG. 14, an illustrative example of the storage sled 1300 is shown. In the illustrative example, the data storage 1350 is implemented as, or otherwise includes, a storage cage 1352 configured to house one or more solid state drives (SSDs) 1354. To do so, the storage cage 1352 includes a number of mounting slots 1356, which are configured to receive corresponding solid-state drives 1354. The mounting slots 1356 include a number of drive guides 1358 that cooperate to define an access opening of the corresponding mounting slot 1356. The storage cage 1352 is secured to the chassis-less circuit board substrate 702 such that the access openings face away from (i.e., toward the front of) the chassis-less circuit board substrate 702. As such, solid state drives 1354 are accessible while the storage sled 1300 is mounted in a corresponding rack 340. For example, a solid-state drive 1354 may be swapped out of a rack 340 (e.g., via a robot) while the storage sled 1300 remains mounted in the corresponding rack 340.

The storage cage 1352 illustratively includes sixteen mounting slots 1356 and is capable of mounting and storing sixteen solid state drives 1354. The storage cage 1352 may be configured to store additional or fewer solid-state drives 1354 in other examples. Additionally, in the illustrative example, the solid-state drives are mounted vertically in the storage cage 1352 but may be mounted in the storage cage 1352 in a different orientation in other examples. A given solid state drive 1354 may be implemented as any type of data storage device capable of storing long term data. To do so, the solid-state drives 1354 may include volatile and non-volatile memory devices discussed above.

As shown in FIG. 14, the storage controllers 1320, the communication circuit 930, and the optical data connector 934 are illustratively mounted to the top side 750 of the chassis-less circuit board substrate 702. Again, as discussed above, any suitable attachment or mounting technology may be used to mount the electrical components of the storage sled 1300 to the chassis-less circuit board substrate 702 including, for example, sockets (e.g., a processor socket), holders, brackets, soldered connections, and/or other mounting or securing techniques.

As discussed above, the individual storage controllers 1320 and the communication circuit 930 are mounted to the top side 750 of the chassis-less circuit board substrate 702 such that no two heat-producing, electrical components shadow each other. For example, the storage controllers 1320 and the communication circuit 930 are mounted in corresponding locations on the top side 750 of the chassis-less circuit board substrate 702 such that no two of those electrical components are linearly in-line with each other along the direction of the airflow path 708.

The memory devices 820 (not shown in FIG. 14) of the storage sled 1300 are mounted to the bottom side 850 (not shown in FIG. 14) of the chassis-less circuit board substrate 702 as discussed above in regard to the sled 500. Although mounted to the bottom side 850, the memory devices 820 are communicatively coupled to the storage controllers 1320 located on the top side 750 via the I/O subsystem 722. Again, because the chassis-less circuit board substrate 702 is implemented as a double-sided circuit board, the memory devices 820 and the storage controllers 1320 may be communicatively coupled by one or more vias, connectors, or other mechanisms extending through the chassis-less circuit board substrate 702. The storage controllers 1320 include and/or are associated with a heatsink 1370 secured thereto. As discussed above, due to the improved thermal cooling characteristics of the chassis-less circuit board substrate 702 of the storage sled 1300, none of the heatsinks 1370 include cooling fans attached thereto. That is, the heatsinks 1370 may be fan-less heatsinks.

Referring now to FIG. 15, in some examples, the sled 500 may be implemented as a memory sled 1500. The storage sled 1500 is optimized, or otherwise configured, to provide other sleds 500 (e.g., compute sleds 900, accelerator sleds 1100, etc.) with access to a pool of memory (e.g., in two or more sets 1530, 1532 of memory devices 820) local to the memory sled 1300. For example, during operation, a compute sled 900 or an accelerator sled 1100 may remotely write to and/or read from one or more of the memory sets 1530, 1532 of the memory sled 1300 using a logical address space that maps to physical addresses in the memory sets 1530, 1532. The memory sled 1500 includes various components similar to components of the sled 500 and/or the compute sled 900, which have been identified in FIG. 15 using the same reference numbers. The description of such components provided above in regard to FIGS. 7, 8, and 9 apply to the corresponding components of the memory sled 1500 and is not repeated herein for clarity of the description of the memory sled 1500.

In the illustrative memory sled 1500, the physical resources 720 include memory controllers 1520. Although only two memory controllers 1520 are shown in FIG. 15, it should be appreciated that the memory sled 1500 may include additional memory controllers 1520 in other examples. The memory controllers 1520 may be implemented as any type of processor, controller, or control circuit capable of controlling the writing and reading of data into the memory sets 1530, 1532 based on requests received via the communication circuit 930. In the illustrative example, the memory controllers 1520 are connected to corresponding memory sets 1530, 1532 to write to and read from memory devices 820 (not shown) within the corresponding memory set 1530, 1532 and enforce any permissions (e.g., read, write, etc.) associated with sled 500 that has sent a request to the memory sled 1500 to perform a memory access operation (e.g., read or write).

In some examples, the memory sled 1500 may also include a controller-to-controller interconnect 1542. Similar to the resource-to-resource interconnect 724 of the sled 500 discussed above, the controller-to-controller interconnect 1542 may be implemented as any type of communication interconnect capable of facilitating controller-to-controller communications. In the illustrative example, the controller-to-controller interconnect 1542 is implemented as a high-speed point-to-point interconnect (e.g., faster than the I/O subsystem 722). For example, the controller-to-controller interconnect 1542 may be implemented as a QuickPath Interconnect (QPI), an UltraPath Interconnect (UPI), or other high-speed point-to-point interconnect dedicated to processor-to-processor communications. As such, in some examples, a memory controller 1520 may access, through the controller-to-controller interconnect 1542, memory that is within the memory set 1532 associated with another memory controller 1520. In some examples, a scalable memory controller is made of multiple smaller memory controllers, referred to herein as “chiplets”, on a memory sled (e.g., the memory sled 1500). The chiplets may be interconnected (e.g., using EMIB (Embedded Multi-Die Interconnect Bridge) technology). The combined chiplet memory controller may scale up to a relatively large number of memory controllers and I/O ports, (e.g., up to 16 memory channels). In some examples, the memory controllers 1520 may implement a memory interleave (e.g., one memory address is mapped to the memory set 1530, the next memory address is mapped to the memory set 1532, and the third address is mapped to the memory set 1530, etc.). The interleaving may be managed within the memory controllers 1520, or from CPU sockets (e.g., of the compute sled 900) across network links to the memory sets 1530, 1532, and may improve the latency associated with performing memory access operations as compared to accessing contiguous memory addresses from the same memory device.

Further, in some examples, the memory sled 1500 may be connected to one or more other sleds 500 (e.g., in the same rack 340 or an adjacent rack 340) through a waveguide, using the waveguide connector 1580. In the illustrative example, the waveguides are 74 millimeter waveguides that provide 16 Rx (i.e., receive) lanes and 16 Tx (i.e., transmit) lanes. Different ones of the lanes, in the illustrative example, are either 16 GHz or 32 GHz. In other examples, the frequencies may be different. Using a waveguide may provide high throughput access to the memory pool (e.g., the memory sets 1530, 1532) to another sled (e.g., a sled 500 in the same rack 340 or an adjacent rack 340 as the memory sled 1500) without adding to the load on the optical data connector 934.

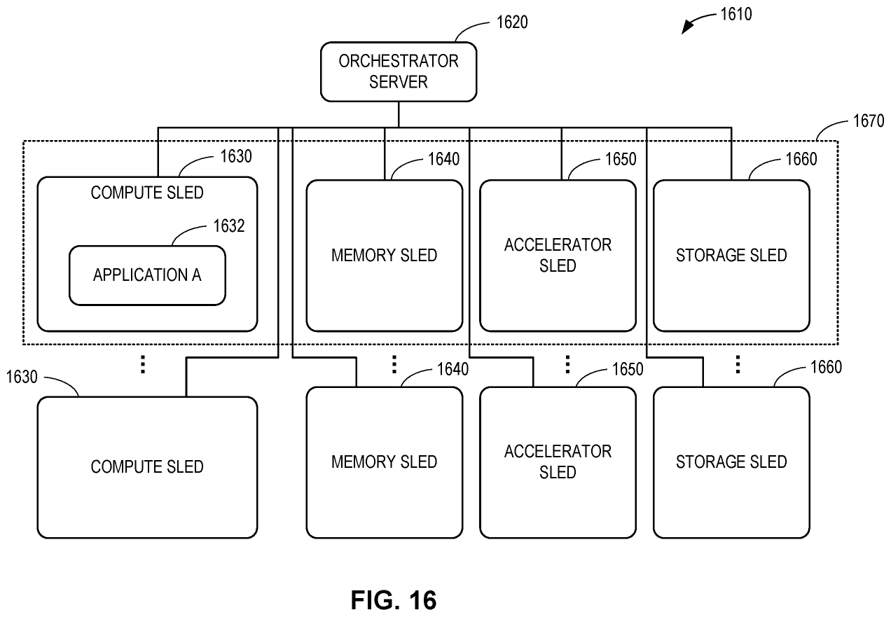

Referring now to FIG. 16, a system for executing one or more workloads (e.g., applications) may be implemented in accordance with the data center 210. In the illustrative example, the system 1610 includes an orchestrator server 1620, which may be implemented as a managed node including a compute device (e.g., programmable circuitry 920 on a compute sled 900) executing management software (e.g., a cloud operating environment, such as OpenStack) that is communicatively coupled to multiple sleds 500 including a large number of compute sleds 1630 (e.g., similar to the compute sled 900), memory sleds 1640 (e.g., similar to the memory sled 1500), accelerator sleds 1650 (e.g., similar to the memory sled 1500), and storage sleds 1660 (e.g., similar to the storage sled 1300). One or more of the sleds 1630, 1640, 1650, 1660 may be grouped into a managed node 1670, such as by the orchestrator server 1620, to collectively perform a workload (e.g., an application 1632 executed in a virtual machine or in a container). The managed node 1670 may be implemented as an assembly of physical resources 720, such as programmable circuitry 920, memory resources 820, accelerator circuits 1120, or data storage 1350, from the same or different sleds 500. Further, the managed node may be established, defined, or “spun up” by the orchestrator server 1620 at the time a workload is to be assigned to the managed node or at any other time, and may exist regardless of whether any workloads are presently assigned to the managed node. In the illustrative example, the orchestrator server 1620 may selectively allocate and/or deallocate physical resources 720 from the sleds 500 and/or add or remove one or more sleds 500 from the managed node 1670 as a function of quality of service (QoS) targets (e.g., a target throughput, a target latency, a target number of instructions per second, etc.) associated with a service level agreement for the workload (e.g., the application 1632). In doing so, the orchestrator server 1620 may receive telemetry data indicative of performance conditions (e.g., throughput, latency, instructions per second, etc.) in different ones of the sleds 500 of the managed node 1670 and compare the telemetry data to the quality-of-service targets to determine whether the quality-of-service targets are being satisfied. The orchestrator server 1620 may additionally determine whether one or more physical resources may be deallocated from the managed node 1670 while still satisfying the QoS targets, thereby freeing up those physical resources for use in another managed node (e.g., to execute a different workload). Alternatively, if the QoS targets are not presently satisfied, the orchestrator server 1620 may determine to dynamically allocate additional physical resources to assist in the execution of the workload (e.g., the application 1632) while the workload is executing. Similarly, the orchestrator server 1620 may determine to dynamically deallocate physical resources from a managed node if the orchestrator server 1620 determines that deallocating the physical resource would result in QoS targets still being met.

Additionally, in some examples, the orchestrator server 1620 may identify trends in the resource utilization of the workload (e.g., the application 1632), such as by identifying phases of execution (e.g., time periods in which different operations, having different resource utilizations characteristics, are performed) of the workload (e.g., the application 1632) and pre-emptively identifying available resources in the data center 210 and allocating them to the managed node 1670 (e.g., within a predefined time period of the associated phase beginning). In some examples, the orchestrator server 1620 may model performance based on various latencies and a distribution scheme to place workloads among compute sleds and other resources (e.g., accelerator sleds, memory sleds, storage sleds) in the data center 210. For example, the orchestrator server 1620 may utilize a model that accounts for the performance of resources on the sleds 500 (e.g., FPGA performance, memory access latency, etc.) and the performance (e.g., congestion, latency, bandwidth) of the path through the network to the resource (e.g., FPGA). As such, the orchestrator server 1620 may determine which resource(s) should be used with which workloads based on the total latency associated with different potential resource(s) available in the data center 210 (e.g., the latency associated with the performance of the resource itself in addition to the latency associated with the path through the network between the compute sled executing the workload and the sled 500 on which the resource is located).

In some examples, the orchestrator server 1620 may generate a map of heat generation in the data center 210 using telemetry data (e.g., temperatures, fan speeds, etc.) reported from the sleds 500 and allocate resources to managed nodes as a function of the map of heat generation and predicted heat generation associated with different workloads, to maintain a target temperature and heat distribution in the data center 210. Additionally or alternatively, in some examples, the orchestrator server 1620 may organize received telemetry data into a hierarchical model that is indicative of a relationship between the managed nodes (e.g., a spatial relationship such as the physical locations of the resources of the managed nodes within the data center 210 and/or a functional relationship, such as groupings of the managed nodes by the customers the managed nodes provide services for, the types of functions typically performed by the managed nodes, managed nodes that typically share or exchange workloads among each other, etc.). Based on differences in the physical locations and resources in the managed nodes, a given workload may exhibit different resource utilizations (e.g., cause a different internal temperature, use a different percentage of processor or memory capacity) across the resources of different managed nodes. The orchestrator server 1620 may determine the differences based on the telemetry data stored in the hierarchical model and factor the differences into a prediction of future resource utilization of a workload if the workload is reassigned from one managed node to another managed node, to accurately balance resource utilization in the data center 210. In some examples, the orchestrator server 1620 may identify patterns in resource utilization phases of the workloads and use the patterns to predict future resource utilization of the workloads.

To reduce the computational load on the orchestrator server 1620 and the data transfer load on the network, in some examples, the orchestrator server 1620 may send self-test information to the sleds 500 to enable a given sled 500 to locally (e.g., on the sled 500) determine whether telemetry data generated by the sled 500 satisfies one or more conditions (e.g., an available capacity that satisfies a predefined threshold, a temperature that satisfies a predefined threshold, etc.). The given sled 500 may then report back a simplified result (e.g., yes or no) to the orchestrator server 1620, which the orchestrator server 1620 may utilize in determining the allocation of resources to managed nodes.

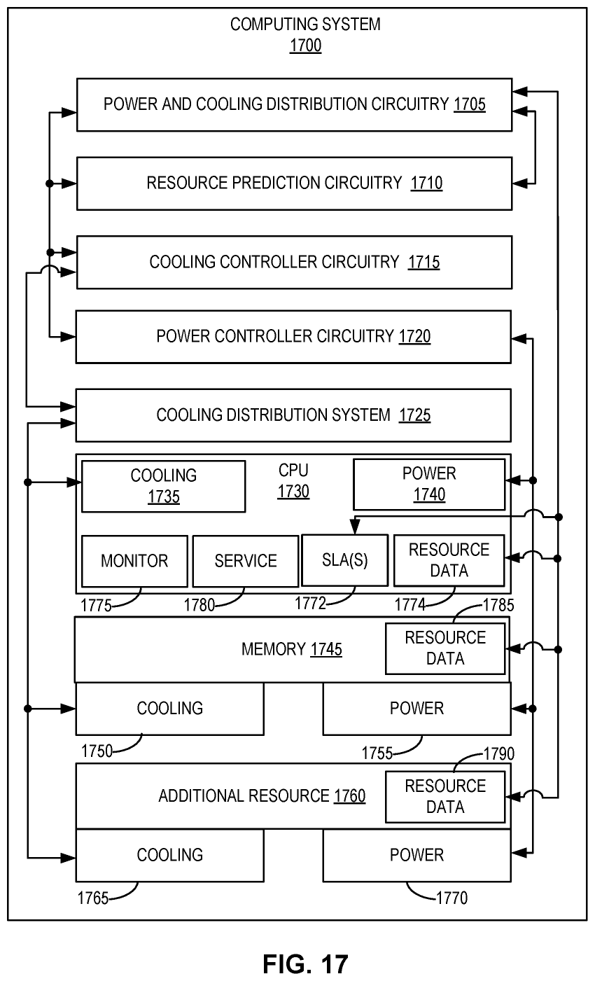

FIG. 17 illustrates an example apparatus or system 1700 for managing power and cooling of one or more compute components (also referred to herein as compute resources) of the example apparatus or system 1700. The example apparatus or system 1700 is referred to herein as a computing system 1700 and includes one or more compute components, disclosed in further detail herein. In the example of FIG. 17, the computing system 1700 includes example power and cooling distribution circuitry 1705, example resource prediction circuitry 1710, example cooling controller circuitry 1715, example power controller circuitry 1720, an example cooling distribution system 1725, an example CPU 1730, a first example cooling system 1735, a first example power system 1740, example memory 1745, a second example cooling system 1750, a second example power system 1755, an example additional resource 1760, a third example cooling system 1765, and a third example power system 1770.

The example computing system 1700 is a collection of one or more compute components (e.g., the CPU 1730, the memory 1745, and the additional resource 1760) configurable to execute workloads. For example, the computing system 1700 may be server, an appliance, a data center, and/or any other type of system having one or more compute component. In some examples, client devices (not illustrated) utilize compute components of the computing system 1700 to perform relatively complex workloads. In such examples, the client devices cause performance of a workload by suppling a description of the workload and SLAs corresponding to performance of the workload to the computing system 1700.

As disclosed above, the computing system 1700 can include one or more compute components. For example, in FIG. 17, the computing system 1700 in FIG. 17 includes the example CPU 1730, the example memory 1745, and the example additional resource 1760. In other examples, the computing system 1700 can include more or fewer compute components. The example compute resources can be used to perform workloads in accordance with one or more SLAs or SLOs.

In the illustrated example, the computing system 1700 includes cooling systems associated with each of the compute components. For example, the CPU 1730 includes the first cooling system 1735, the memory 1745 includes the second cooling system 1750, and the additional resource 1760 includes the third cooling system 1765. Each of the cooling systems 1735, 1750, 1765 can include a cooling plate, a heat sink, a heat exchanger, and/or another type of cooling device for cooling the respective compute component. In some examples, the cooling systems 1735, 1750, 1765 are integrated into and/or coupled to the respective compute resources. In other examples, the cooling systems 1735, 1750, 1765 can be disposed near their respective compote resource (e.g., a heat exchanger near the CPU 1730 that blows cool air on the CPU 1730). The cooling systems 1735, 1750, 1765 are fluidly coupled to the cooling distribution system 1725. In this example, each of the cooling systems 1735, 1750, 1765 receives cooling fluid (e.g., coolant) from the cooling distribution system 1725. The cooling distribution system 1725 may include a storage tank of excess cooling fluid, valves, pipes, and/or other devices for controlling the distribution of cooling fluid to the cooling systems 1735, 1750, 1765. The cooling distribution system 1725 can increase or decrease the flow of cooling liquid to any of the cooling systems 1735, 1750, 1765 to increase or decrease the cooling capability for the associated system. The cooling distribution system 1725 is controlled by the cooling controller circuitry 1715, disclosed in further detail herein. While in this example the cooling distribution system 1725 is a liquid distribution system, in other examples, the cooling distribution system 1725 may be an air distribution system that distributes air (e.g., cold air) to the cooling systems 1735, 1750, 1765.

In the illustrated example, the computing system 1700 includes power systems associated with each of the compute resources. For example, the CPU 1730 includes the first power system 1740, the memory 1745 includes the second power system 1755, and the additional resource 1760 includes the third power system 1770. Each of the power systems 1740, 1755, 1770 can include power supply circuitry, clock generation circuitry, and/or another type of power device for supplying and/or regulating power to the respective compute component. In some examples, the power systems 1740, 1755, 1770 are integrated into and/or coupled to the respective compute resources. In other examples, the power systems 1740, 1755, 1770 can be disposed near their respective compote resource (e.g., a power supply near the CPU 1730 that supplies power from a battery or grid connection). The power systems 1740, 1755, 1770 are electrically and/or communicatively coupled to the power controller circuitry 1720. In some examples, one or more of the power systems 1740, 1755, 1770 receives power from the power controller circuitry 1720. In such examples, the power controller circuitry 1720 configures a frequency of one or more of the power systems 1740, 1755, 1770. The power systems 1740, 1755, and/or 1770 may be coupled to a battery and/or a power grid. The power controller circuitry 1720 can increase or decrease the supply of power to any of the power systems 1740, 1755, 1770 to increase or decrease the power consumption for the associated system.

The example CPU 1730 is in communication with the circuitries 1705 and 1720. In the example of FIG. 17, the CPU 1730 includes the first cooling system 1735, the first power system 1740, example SLAs 1772, first example resource data 1774, an example monitoring system 1775, and an example service 1780. The example CPU 1730 causes performance of and/or performs workloads using the service 1780. The example CPU 1730 monitors performance of workloads using the monitoring system 1775. In some examples, the monitoring system 1775 determines whether the SLAs 1772 and the of the CPU 1730 and/or the workload are being met.

The example CPU 1730 supplies the SLAs 1772 to the power and cooling distribution circuitry 1705. The example SLAs 1772 include one or more cooling terms, power terms and/or performance terms corresponding to performance of a corresponding workload. In some examples, the SLAs 1772 include performance terms that identify specific compute resources, such as the CPU 1730, a GPU, an FPGA, etc. In such examples, the SLAs 1772 may further include power terms specific to the identified compute resources, such as a number of cores of the CPU 1730, a percentage of a total capacity of a compute resource, etc. For example, a first SLA of the SLAs 1772 identifies use of two cores of the CPU 1730 to perform at least a portion of a corresponding workload. In such an example, a second SLA of the SLAs 1772 identifies use of ten percent of a GPUs total capacity to perform at least a portion of the corresponding workload.

The example CPU 1730 supplies the first resource data 1774 to the power and cooling distribution circuitry 1705. The first example resource data 1774 includes one or more cooling thresholds and/or power thresholds of the CPU 1730. The first example resource data 1774 represents characteristics of the CPU 1730. Accordingly, the first example resource data 1774 may be predetermined by a manufacturer, designer of the computing system 1700, etc.

Cooling thresholds represent a level of cooling per performance. In some examples, the first resource data 1774 defines cooling thresholds in relation to performance of the CPU 1730. For example, a first cooling threshold of the first resource data 1774 specifies that the CPU 1730 should be cooled to eighty degrees Fahrenheit when operating at eight percent capacity. In such an example, a second cooling threshold of the first resource data 1774 specifies that the CPU 1730 should be cooled to one-hundred degrees Fahrenheit when operating at fifty percent capacity.

Power thresholds represent a level of performance per power being supplied. In some examples, the first resource data 1774 defines performance in relation to power thresholds of the CPU 1730. For example, a first power threshold of the first resource data 1774 specifies that the CPU 1730 operates at five percent capacity when supplied one Watt (W) of power. In such an example, a second power threshold of the first resource data 1740 specifies that the CPU 1730 operates at eighty percent capacity when supplied nine Watts of power.

The example service 1780 represents performance of a workload using the CPU 1730. In some examples, the service 1780 is a function-as-a-service (FaaS). The example service 1780 may be a plurality of operations that when executed correspond to performance of the workload.

The example memory 1745 is in communication with the power and cooling distribution circuitry 1705 and the power controller circuitry 1720. In the example of FIG. 17, the example memory 1745 includes second example resource data 1785. The example memory 1745 stores data. In some examples, the memory 1745 is a storage medium capable of relatively high read and/or write speeds. In such examples, the memory 1745 includes an SLA that has a resource term to ensure the second power system 1755 supplies a clock of a frequency greater than a minimum frequency. In other examples, the memory 1745 is a volatile storage medium that requires a continuous power supply from the second power system 1755 to store data. In such examples, the memory 1745 includes an SLA that has a resource term to ensure the second power system 1755 supplies a minimum amount when storing data of a workload.

The example memory 1745 supplies the second resource data 1785 to the power and cooling distribution circuitry 1705. The second example resource data 1785 includes one or more cooling thresholds and/or power thresholds of the memory 1745. The second example resource data 1785 represents characteristics of the memory 1745. Accordingly, the second example resource data 1785 may be predetermined by a manufacturer, designer of the computing system 1700, etc.

The example additional resource 1760 is in communication with the power and cooling distribution circuitry 1705 and the power controller circuitry 1720. In the example of FIG. 17, the example additional resource 1760 includes third example resource data 1790. The example additional resource 1760 illustrates integration of additional resources into the computing system 1700. In some examples, the computing system 1700 includes one or more compute components, such as CPUs, memories, graphical processing units (GPUs), field programmable gate arrays (FPGAs), branch prediction units (BPUs), discrete devices, etc. The one or more additional resources are to be coupled to cooling and power systems, similar to the additional resource 1760. The example additional resource 1760 may perform workloads.

The example additional resource 1760 supplies the third resource data 1790 to the power and cooling distribution circuitry 1705. The third example resource data 1790 includes one or more cooling thresholds and/or power thresholds of the additional resource 1760. The third example resource data 1790 represents characteristics of the additional resource 1760. Accordingly, the third example resource data 1790 may be predetermined by a manufacturer, designer of the computing system 1700, etc.

In some examples, the computing system 1700 has access to limited cooling resources and/or power resources. For example, the computing system 1700 may be an off-grid server with access to power resources of a battery rechargeable by a renewable resource, such as a solar panel, a wind turbine, etc. In such an example, the computing system 1700 attempts to orchestrate cooling resources to reduce power consumption per performance. In another example, the computing system 1700 may be geographically located in a location known for relatively high ambient temperatures. In such an example, the computing system 1700 attempts to orchestrate power resources to reduce circulation rates of coolant.

The example power and cooling distribution circuitry 1705 is in communication with the circuitries 1710-1720. The example power and cooling distribution circuitry 1705 receives predictions (e.g., estimates, approximations) of amounts of cooling and/or power resources are needed to perform subsequent workloads from the resource prediction circuitry 1710. The example power and cooling distribution circuitry 1705 receives predictions of ambient temperatures from the resource prediction circuitry 1710. The example power and cooling distribution circuitry 1705 receives the SLAs 1772 from the CPU 1730. The example power and cooling distribution circuitry 1705 receives the resource data 1774, 1785, and 1790.

The example power and cooling distribution circuitry 1705 generates a cooling budget based on the predictions, from the resource prediction circuitry 1710, the SLAs 1772, and the resource data 1774, 1785, and 1790. The cooling budget specifies an amount of cooling resources the example cooling controller circuitry 1715 may allocate at a given time.

In some examples, the cooling budget includes amounts of liquid coolant to supply to the cooling systems 1735, 1750, and/or 1765. In such examples, the amounts of liquid coolant satisfy the SLAs 1772 of a workload and thresholds of the resource data 1774, 1785, and 1790.

In other examples, the cooling budget includes amounts of air coolant to supply to the cooling systems 1735, 1750, and/or 1765. In such examples, the amounts of air coolant satisfy the SLAs 1772 of a workload and thresholds of the resource data 1774, 1785, and 1790.

The example power and cooling distribution circuitry 1705 generates a power budget based on the predictions, from the resource prediction circuitry 1710, the SLAs 1772, and the resource data 1774, 1785, and 1790. The power budget specifies an amount of power resources the example power controller circuitry 1720 may allocate at a given time.

In some examples, the power budget includes amounts of power to supply to the power systems 1740, 1755, and/or 1770. In such examples, the amounts of power satisfy the SLAs 1772 of a workload and thresholds of the resource data 1774, 1785, and 1790.

In other examples, the power budget includes clock speeds to supply to the power systems 1740, 1755, and/or 1770. In such examples, the clock speeds satisfy the SLAs 1772 of a workload and thresholds of resource data 1774, 1785, and 1790.

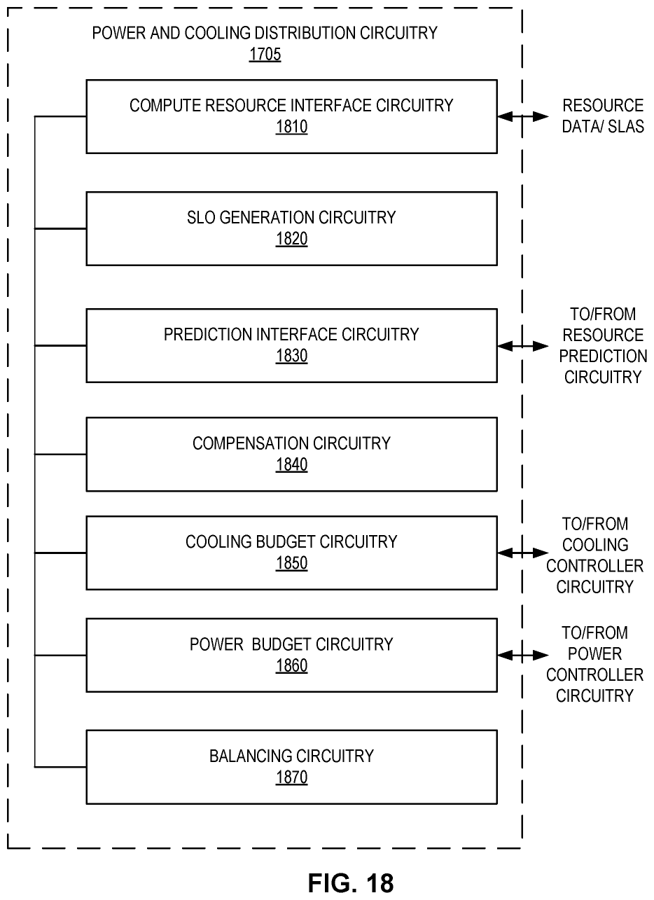

The example power and cooling distribution circuitry 1705 supplies allocation information to the controller circuitries 1715 and 1720. The example controller circuitries 1715 and 1720 control the allocation of cooling and power resources, respectively, based on the allocation information. For example, the cooling controller circuitry 1715 can control the cooling distribution system 1725 to supply more or less cooling fluid to certain ones of the cooling systems 1735, 1750, 1765. Similarly, the power controller circuitry 1720 can control and/or regulate the amount of power accessed by the power systems 1740, 1755, 1770. Therefore, the power and cooling distribution circuitry 1705 controls the allocation of resources (e.g., cooling fluid and power supply) to the compute components. An example of the power and cooling distribution circuitry 1705 is illustrated in further detail in FIG. 18.

The example resource prediction circuitry 1710 is in communication with the circuitries 1705, 1715, and 1720. The example resource prediction circuitry 1710 receives cooling resource usage data from the cooling controller circuitry 1715. The cooling resource usage data includes data relating to cooling resources that the example cooling controller circuitry 1715 is allocating to the compute components. In some examples, the cooling resource usage data specifies an amount of coolant currently being allocated to the compute resources. The example resource prediction circuitry 1710 receives power resource usage data from the power controller circuitry 1720. The power resource usage data includes data relating to power resources that the example power controller circuitry 1720 is allocating at a given time.

The example resource prediction circuitry 1710 determines resource usage predictions based on the cooling resource usage data, the power resource usage data, and previous resource usage data. The resource usage predictions represent cooling resource usage and/or power resource usage at a given subsequent time (e.g., N minutes and/or hours in the future). In some examples, the resource prediction circuitry 1710 generates resource usage data predictions using a data model, such as a machine learning model, long short-term memory network (LSTM), neural network, etc. The example resource prediction circuitry 1710 supplies the resource usage predictions to the power and cooling distribution circuitry 1705.

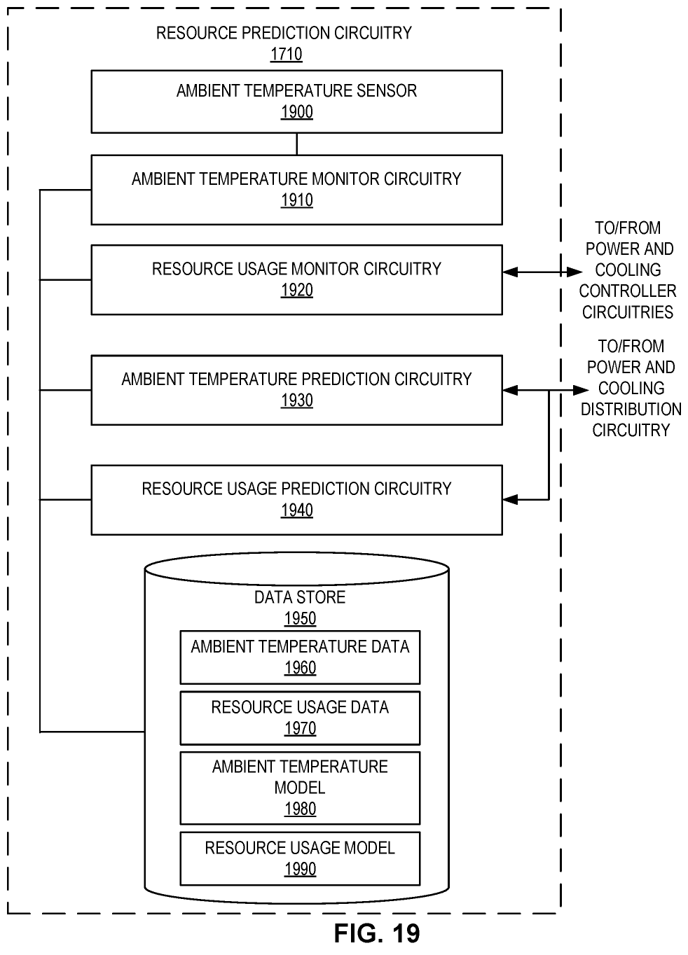

An example of the resource prediction circuitry 1710 is illustrated in further detail in FIG. 19.

The example cooling controller circuitry 1715 is in communication with the circuitries 1705 and 1710 and the cooling distribution system 1725. The example cooling controller circuitry 1715 receives cooling allocation information from the power and cooling distribution circuitry 1705. The cooling allocation information includes data relating to an amount of cooling that the example cooling distribution system 1725 is to supply the cooling systems 1735, 1750, and/or 1765.

The example cooling controller circuitry 1715 allocates cooling resources based on the cooling allocation information. In some examples, the cooling controller circuitry 1715 modifies an amount of liquid coolant the cooling distribution circuitry 1725 supplies to the cooling systems 1735, 1750, and/or 1765. In other examples, the cooling controller circuitry 1715 modifies an amount of air coolant the cooling distribution circuitry 1725 supplies to the cooling systems 1735, 1750, and/or 1765. In such examples, the cooling controller circuitry 1715 causes the cooling distribution circuitry 1725 to modify a speed of a fan to modify the amount of air coolant. The example cooling controller circuitry 1715 supplies coolant control information to the example cooling distribution system 1725 to modify usage of cooling resources.

The example cooling controller circuitry 1715 may utilize control technologies, such as Intel's Speed Select Technology (SST).

The example power controller circuitry 1720 is in communication with the circuitries 1705 and 1710 and the power systems 1740, 1755, and 1770. The example power controller circuitry 1720 receives power allocation information from the power and cooling distribution circuitry 1705. The power allocation information includes data relating to an amount of power the power systems 1740, 1755, and/or 1755 are to supply to a corresponding resource (e.g., the CPU 1730, the memory 1745, and/or the additional resource 1760).

The example power controller circuitry 1720 allocates power resources based on the power allocation information. In some examples, the power controller circuitry 1720 modifies an amount of power the power systems 1740, 1755, and/or 1770 utilizes. In other examples, the power controller circuitry 1720 modifies a clock speed of the power systems 1740, 1755, and/or 1770. In such examples, the cooling controller circuitry 1715 modifies power consumption of a resource by modifying the clock speed. The example power controller circuitry 1720 supplies power control information to the power systems 1740, 1755, and/or 1770.

The example power controller circuitry 1720 may utilize control technologies, such as Intel's Speed Select Technology (SST).

The example cooling distribution system 1725 is in communication with the cooling controller circuitry 1715 and the cooling systems 1735, 1750, and 1765. The example cooling distribution system 1725 receives coolant control data from the cooling controller circuitry 1715. The coolant control data includes data relating to an amount of coolant to supply to the cooling systems 1735, 1750, and/or 1765.

The example cooling distribution system 1725 supplies coolant to the cooling systems 1735, 1750, and/or 1765 based on the coolant control information. In some examples, the cooling distribution circuitry 1725 supplies an amount of liquid coolant to the cooling systems 1735, 1750, and/or 1765 based on the coolant control information. In other examples, the cooling distribution circuitry 1725 supplies an amount of air coolant to the cooling systems 1735, 1750, and/or 1765 based on the coolant control information. In such examples, the coolant control information may specify a fan speed, a number of fans, etc. The example cooling distribution system 1725 causes the cooling systems 1735, 1750, and/or 1765 to cool a corresponding resource, such as the CPU 1730, the memory 1745, and/or the additional resource 1760.

FIG. 18 is a block diagram of the power and cooling distribution circuitry 1705 of FIG. 17 used to balance and coordinate power and cooling resources. The power and cooling distribution circuitry 1705 of FIG. 17 may be instantiated (e.g., creating an instance of, bring into being for any length of time, materialize, implement, etc.) by programmable circuitry such as a central processing unit executing instructions. Additionally or alternatively, the power and cooling distribution circuitry 1705 of FIG. 17 may be instantiated (e.g., creating an instance of, bring into being for any length of time, materialize, implement, etc.) by an ASIC or an FPGA structured to perform operations corresponding to the instructions. It should be understood that some or all of the power and cooling distribution circuitry 1705 of FIG. 17 may, thus, be instantiated at the same or different times. Some or all of the power and cooling distribution circuitry 1705 of FIG. 17 may be instantiated, for example, in one or more threads executing concurrently on hardware and/or in series on hardware. Moreover, in some examples, some or all of the power and cooling distribution circuitry 1705 of FIG. 17 may be implemented by microprocessor circuitry executing instructions to implement one or more virtual machines and/or containers.

In the example of FIG. 18, the power and cooling distribution circuitry 1705 includes example compute resource interface circuitry 1810, example service level objective (SLO) generation circuitry 1820, example prediction interface circuitry 1830, example compensation circuitry 1840, example cooling budget circuitry 1850, example power budget circuitry 1860, and example balancing circuitry 1870.

The example compute resource interface circuitry 1810 is in communication with the compute components including the CPU 1730 of FIG. 17, the memory 1745 of FIG. 17, and the additional resource 1760 of FIG. 17. The example compute resource interface circuitry 1810 receives the SLAs 1772 of FIG. 17 from the CPU 1730. The example compute resource interface circuitry 1810 receives the resource data 1774, 1785, and 1790 from the CPU 1730, the memory 1745, and the additional resource 1760 of FIG. 17.

In some examples, the SLAs 1772 include identification information corresponding to a specific compute resource (e.g., the CPU 1730, the memory 1745, and the additional resource 1760) of the compute system 1700 of FIG. 17. In such examples, the SLAs 1772 correspond to a workload to be performed by resources of a system. The SLAs 1772 may include identification information corresponding to the workload. The example compute resource interface circuitry 1810 supplies the SLAs 1772 to the SLO generation circuitry 1820.

The example resource data 1774, 1785, and 1790 includes cooling thresholds and/or power thresholds specific to a corresponding one of the CPU 1730, the memory 1745, and the additional resource 1760. In some examples, the resource data 1774, 1785, and 1790 includes identification information to identify a specific compute resource (e.g., the CPU 1730, the memory 1745, and the additional resource 1760). In such examples, the identification information of the resource data 1774, 1785, and 1790 corresponds to the identification information of the SLAs 1772. The example compute resource interface circuitry 1810 supplies the resource data 1774, 1785, and 1790 to the SLO generation circuitry 1820, the compensation circuitry 1840, and the balancing circuitry 1870.

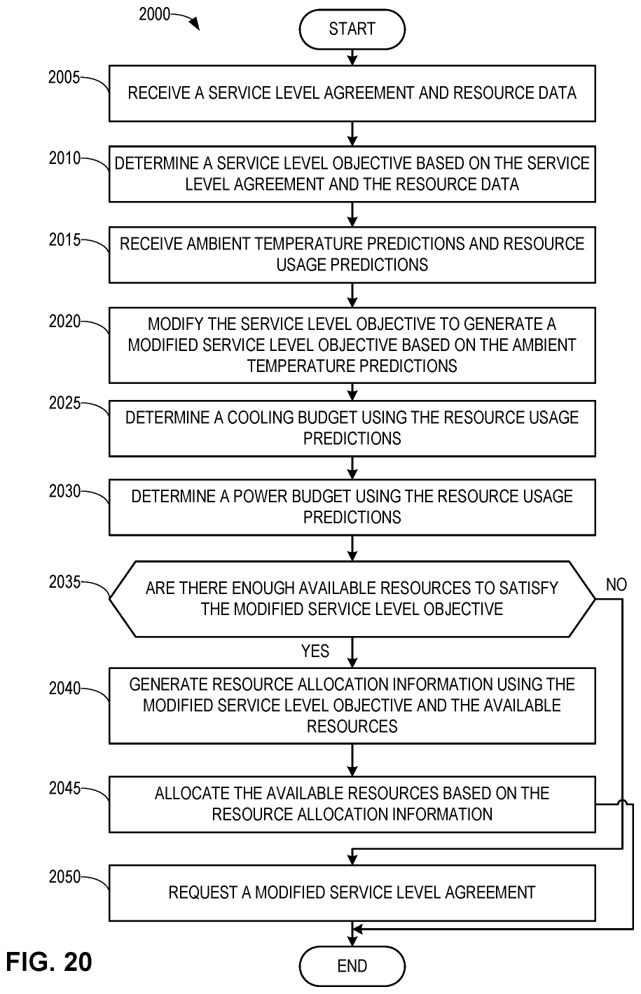

In some examples, the compute resource interface circuitry 1810 is instantiated by programmable circuitry executing compute resource interface instructions and/or configured to perform operations such as those represented by the flowchart of FIG. 20.

The example SLO generation circuitry 1820 receives the SLAs 1772 from the compute resource interface circuitry 1810. The example SLO generation circuitry 1820 parses the SLAs 1772 by identification information. In some examples, the SLO generation circuitry 1820 uses the identification information of the SLAs 1772 to parse by workloads and/or resources. The example SLO generation circuitry 1820 receives the resource data 1774, 1785, and 1790 from the compute resource interface circuitry 1810. The example SLO generation circuitry 1820 maps the SLAs 1772 to thresholds of the resource data 1774, 1785, and 1790 based on the identification information.

The example SLO generation circuitry 1820 selects one of the thresholds of the resource data 1774, 1785, and 1790 to map the SLAs 1772. For examples, the SLO generation circuitry 1820 maps an SLA specifying use of two compute cores of the CPU 1730 to a power threshold specifying fifty percent capacity when the CPU 1730 includes four total compute cores. In another example, the SLO generation circuitry 1820 maps an SLA specifying a one-hundred Megahertz (MHz) clock cycle of the memory 1745 to a power threshold specifying a clock frequency nearest to one-hundred MHz. The selected thresholds of the example resource data 1774, 1785, and 1790 that satisfy the SLAs 1772 are SLOs. The example SLO generation circuitry 1820 supplies the SLOs to the compensation circuitry 1840.

In some examples, the SLO generation circuitry 1820 is instantiated by programmable circuitry executing SLO generation instructions and/or configured to perform operations such as those represented by the flowchart of FIG. 20.

The example prediction interface circuitry 1830 is configured to be coupled to the resource prediction circuitry 1710 of FIG. 17. The example prediction interface circuitry 1830 receives resource usage predictions from the resource prediction circuitry 1710. The example prediction interface circuitry 1830 receives ambient temperature predictions from the resource prediction circuitry 1710. The example prediction interface circuitry 1830 supplies the ambient temperature predictions to the compensation circuitry 1840. The example prediction interface circuitry 1830 supplies the resource usage predictions to the cooling budget circuitry 1850 and/or the power budget circuitry 1860.

In some examples, the prediction interface circuitry 1830 is instantiated by programmable circuitry executing prediction interface instructions and/or configured to perform operations such as those represented by the flowchart of FIG. 20.

The example compensation circuitry 1840 receives the resource data 1774, 1785, and 1790 from the compute resource interface circuitry 1810. The example compensation circuitry 1840 receives the SLOs from the SLO generation circuitry 1820. The example compensation circuitry 1840 receives ambient temperature predictions from the prediction interface circuitry 1830. The example compensation circuitry 1840 generates compensated SLOs for the ambient temperatures from the ambient temperature predictions.

In some examples, the compensation circuitry 1840 compensates the SLOs based on a current ambient temperature. In such examples, the compensation circuitry 1840 determines an amount to compensate the SLOs based on a difference between conditions in which the SLOs are assumed to be perform in and the current ambient temperature. The conditions in which the SLOs are assumed to be performed in may be in reference to standard temperature and pressure and/or reference conditions. In some examples, the difference between conditions corresponds to a difference between an environment in which the resource data 1774, 1785, and 1790 has been determined.

In some examples, the compensation circuitry 1840 modifies an SLO corresponding to a first power threshold to a second power threshold to compensate for relatively low ambient temperatures. In such examples, the compensation circuitry 1840 selects the second power threshold based on the difference between an assumed temperature in which the first power threshold was determined and the relatively low ambient temperature. For example, the compensation circuitry 1840 modifies a first power threshold of an SLO corresponding to two compute cores of the CPU 1730 to a second power threshold corresponding to three compute cores. In such an example, the second power threshold compensates the SLO for the relatively low ambient temperature.

In other examples, the compensation circuitry 1840 modifies an SLO corresponding to a first power threshold to a second power threshold to compensate for relatively high ambient temperatures. In such examples, the compensation circuitry 1840 selects the second power threshold based on the difference between an assumed temperature in which the first power threshold was determined and the relatively high ambient temperature. For example, the compensation circuitry 1840 modifies a first power threshold of an SLO corresponding to two compute cores of the CPU 1730 to a second power threshold corresponding to one compute core. In such an example, the second power threshold compensates the SLO for the relatively high ambient temperature.

The example compensation circuitry 1840 supplies the compensated SLOs to the balancing circuitry 1870.

In some examples, the compensation circuitry 1840 is instantiated by programmable circuitry executing compensation instructions and/or configured to perform operations such as those represented by the flowchart of FIG. 20.

The example cooling budget circuitry 1850 is in communication with to the cooling controller circuitry 1715 of FIG. 17. The example cooling budget circuitry 1850 receives total cooling resources information from the cooling controller circuitry 1715. The total cooling resources information represents accessible cooling resources in a given system (e.g., the computing system 1700). For example, the total cooling resources information represents an amount of liquid coolant in the computing system 1700. In another example, the total cooling resources information represents an amount of air that may be circulated through the computing system 1700. The example cooling budget circuitry 1850 receives the resource usage predictions from the prediction interface circuitry 1830. The example cooling budget circuitry 1850 receives cooling resource allocation information from the balancing circuitry 1870. The cooling resource allocation information specifies an amount of cooling resources to allocate to a specific resource.

The example cooling budget circuitry 1850 generates a resource budget based on total cooling resources, the resource usage predictions, and the cooling resource allocation information. Such a resource budget may be referred to as a cooling budget. The cooling budget specifies available cooling resources at a given time. The example cooling budget circuitry 1850 allocates a portion of the total cooling resources for future use based on the resource usage predictions. In some examples, the cooling budget circuitry 1850 allocates a relatively large portion of the total cooling resources to prepare for predictions of relatively high resource usage. In such examples, the cooling budget circuitry 1850 allocates a relatively small portion of the total cooling resources to prepare for predictions of relatively low resource usage.

The example cooling budget circuitry 1850 determines available cooling resources to be the total cooling resources minus the cooling resources allocated for future use. The example cooling budget circuitry 1850 generates available cooling resource information to identify the available cooling resources. The example cooling budget circuitry 1850 supplies the available cooling resource information to the balancing circuitry 1870.

The example cooling budget circuitry 1850 allocates the available cooling resources by supplying the cooling resource allocation information, from the balancing circuitry 1870, to the cooling controller circuitry 1715.

In some examples, the cooling budget circuitry 1850 is instantiated by programmable circuitry executing cooling budget instructions and/or configured to perform operations such as those represented by the flowchart of FIG. 20.

The example power budget circuitry 1860 is configured to be coupled to the power controller circuitry 1720 of FIG. 17. The example power budget circuitry 1860 receives total power resource information from the power controller circuitry 1720. The total power resource information represents all power resources and/or generation capabilities that are in a system (e.g., the computing system 1700). In some examples, the total power resource information specifies an amount of power left in a battery. In such examples, the total power resource information may specify an amount of power being supplied to the battery and/or system. For example, a system that is powered by a solar panel may rely on power from a battery when the solar panel is not suppling power. The example power budget circuitry 1860 receives the resource usage predictions from the prediction interface circuitry 1830. The example power budget circuitry 1860 receives power resource allocation information from the balancing circuitry 1870. The power resource allocation information specifies allocation of power resources.

The example power budget circuitry 1860 generates a resource budget based on total power resources, the resource usage predictions, and the power resource allocation information. Such a resource budget may be referred to as a power budget. The power budget specifies available power resources at a given time. The example power budget circuitry 1860 allocates a portion of the total power resources for future use based on resource usage predictions from the resource prediction circuitry 1710. In some examples, the power budget circuitry 1860 allocates a relatively large portion of the total power resources to prepare for predictions of relatively high resource usage. In such examples, the power budget circuitry 1860 allocates a relatively small portion of the total power resources to prepare for predictions of relatively low resource usage.

The example power budget circuitry 1860 determines available power resources to be the total power resources minus the power resources allocated for future use. The example power budget circuitry 1860 generates available power resource information to identify the available power resources. The example power budget circuitry 1860 supplies the available power resource information to the balancing circuitry 1870.

The example power budget circuitry 1860 allocates the available power resources by supplying the power resource allocation information, from the balancing circuitry 1870, to the power controller circuitry 1720.

In some examples, the power budget circuitry 1860 is instantiated by programmable circuitry executing power budget instructions and/or configured to perform operations such as those represented by the flowchart of FIG. 20.

The example balancing circuitry 1870 receives the resource data 1774, 1785, and 1790 from the compute resource interface circuitry 1810. The example balancing circuitry 1870 receives the compensated SLOs from the compensation circuitry 1840. The example balancing circuitry 1870 receives the available cooling resource information from the power budget circuitry 1860. The example balancing circuitry 1870 receives power resource information from the power budget circuitry 1860.

The example balancing circuitry 1870 determines the available cooling resources from the available cooling resource information. In some examples, the available cooling resources specifies an amount of coolant. In other examples, the available cooling resources specifies an amount of air coolant that may be circulated. The example balancing circuitry 1870 determines the available power resources from the available power resource information. In some examples, the available power resources specify a capacity of a battery and/or a power supply. In other examples, the available power resources specify a minimum and/or maximum clock speeds.

The example balancing circuitry 1870 determines if there are enough available cooling resources and/or available power resources to meet the compensated SLOs. In some examples, the balancing circuitry 1870 causes the compute resource interface circuitry 1810 to reject an SLA that may not be accomplished using the available cooling resources and/or the available power resources. In such examples, the compute resource interface circuitry 1810 causes the resource and/or the workload, corresponding to the SLA, to create a subsequent SLA or postpone operations.

The example balancing circuitry 1870 generates allocation information by balancing the available cooling resources and/or the available power resources. The allocation information including cooling allocation information and power allocation information. The example balancing circuitry 1870 balances available cooling and/or power resources by modifying the compensated SLOs. The example balancing circuitry 1870 selects thresholds from the resource data 1774, 1785, and 1790 based on the compensated SLOs and the available cooling resources and/or the available power resources.

In some examples, the balancing circuitry 1870 balances the available cooling resources and/or the available power resources to increase energy efficiency. In such examples, the balancing circuitry 1870 attempts to select power thresholds from the resource data 1774, 1785, and/or 1790 that satisfy the compensated SLOs and increase performance per Watt. For example, the balancing circuitry 1870 modifies an SLO of the CPU 1730 from a first power threshold corresponding to five percent capacity per one Watt to a second power threshold corresponding to eight percent capacity per one Watt. In such an example, the first power threshold corresponds to five percent capacity of the CPU 1730, while the second power threshold corresponds to eighty percent capacity of the CPU 1730.

In some examples, the balancing circuitry 1870 balances the available cooling resources and/or the available power resources to increase resource usage. In such examples, the balancing circuitry 1870 attempts to allocate as much of the available resources as possible. For example, the balancing circuitry 1870 modifies an SLO of the CPU 1730 from a first power threshold corresponding to five percent capacity to a second power threshold corresponding to eighty percent capacity. In such an example, the balancing circuitry 1870 determines the available cooling resources and the available power resources allow for an increase in capacity of the CPU 1730. In another example, the balancing circuitry 1870 modifies an SLO of the CPU 1730 from a first power threshold corresponding to five percent capacity to a second power threshold corresponding to fifty percent capacity. In such an example, the balancing circuitry 1870 determines the available cooling resources allows for an increase in capacity of the CPU 1730, however limits usage of the available power resources.

The example balancing circuitry 1870 supplies the cooling allocation information to the cooling budget circuitry 1850. The example balancing circuitry 1870 supplies the power allocation information to the power budget circuitry 1860.

In some examples, the balancing circuitry 1870 is instantiated by programmable circuitry executing balancing instructions and/or configured to perform operations such as those represented by the flowchart of FIG. 20.

FIG. 19 is a block diagram of the example resource prediction circuitry 1710 of FIG. 17 used to predict ambient temperatures and resources usage. The example resource prediction circuitry 1710 of FIG. 17 may be instantiated (e.g., creating an instance of, bring into being for any length of time, materialize, implement, etc.) by programmable circuitry such as a central processing unit executing instructions. Additionally or alternatively, the example resource prediction circuitry 1710 of FIG. 17 may be instantiated (e.g., creating an instance of, bring into being for any length of time, materialize, implement, etc.) by an ASIC or an FPGA structured to perform operations corresponding to the instructions. It should be understood that some or all of the example resource prediction circuitry 1710 of FIG. 17 may, thus, be instantiated at the same or different times. Some or all of the example resource prediction circuitry 1710 of FIG. 17 may be instantiated, for example, in one or more threads executing concurrently on hardware and/or in series on hardware. Moreover, in some examples, some or all of the example resource prediction circuitry 1710 of FIG. 17 may be implemented by microprocessor circuitry executing instructions to implement one or more virtual machines and/or containers.

In the example of FIG. 19, the example resource prediction circuitry 1710 includes an example ambient temperature sensor 1900, example ambient temperature monitor circuitry 1910, example resource usage monitor circuitry 1920, example ambient temperature prediction circuitry 1930, example resource usage prediction circuitry 1940, and an example data store 1950. The example data store 1950 includes example ambient temperature data 1960, example resource usage data 1970, an example ambient temperature model 1980, and an example resource usage model 1990.

The example ambient temperature sensor 1900 is coupled to the ambient temperature monitor circuitry 1910. The example ambient temperature sensor 1900 determines a current ambient temperature. In some examples, the ambient temperature sensor 1900 is positioned near a compute component. In such examples, the ambient temperature sensor 1900 measures the ambient temperature specific to the environment immediately surrounding the compute component. In other examples, the ambient temperature sensor 1900 is positioned inside of the compute system 1700. In such examples, the ambient temperature sensor 1900 measures the ambient temperature specific to the environment immediately of the compute system 1700. The example ambient temperature sensor 1900 supplies the current ambient temperature to the ambient temperature monitor circuitry 1910.

The example ambient temperature monitor circuitry 1910 receives the ambient temperature from the ambient temperature sensor 1900. In some examples, the ambient temperature monitor circuitry 1910 determines the ambient temperature based on a measurement of the ambient temperature sensor 1900. In such examples, the ambient temperature monitor circuitry 1910 determines a characteristic of the ambient temperature sensor 1900 that varies with the ambient temperature, such as an output voltage, a resistance, an impedance, an output current, etc.

The example ambient temperature monitor circuitry 1910 stores the ambient temperature in the ambient temperature data 1960. In some examples, the ambient temperature monitor circuitry 1910 stores ambient temperatures periodically into the ambient temperature data 1960. The example ambient temperature data 1960 stores previous ambient temperatures as a collection of ambient temperatures over time.

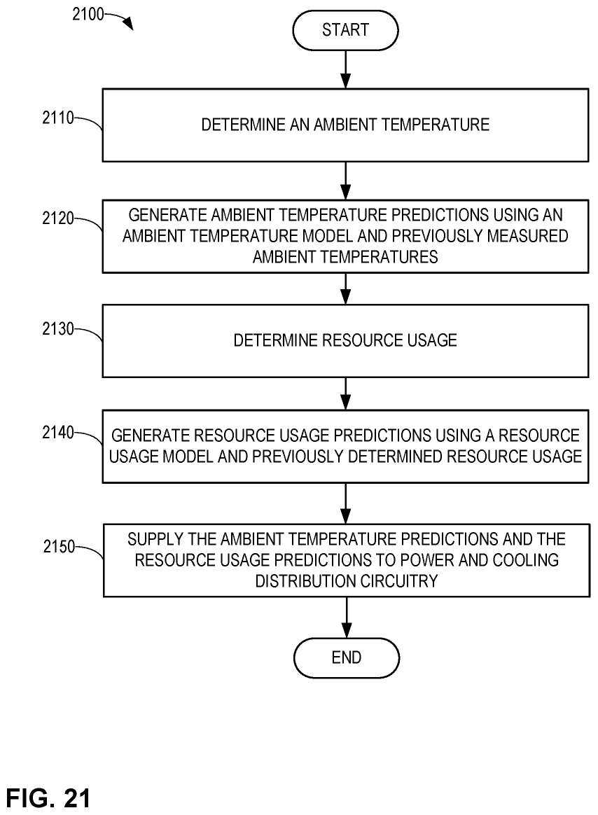

In some examples, the ambient temperature monitor circuitry 1910 is instantiated by programmable circuitry executing ambient temperature monitor instructions and/or configured to perform operations such as those represented by the flowchart of FIG. 21.

In the example of FIG. 19, the resource usage monitor circuitry 1920 is configured to be coupled to the controller circuitries 1715 and 1720 of FIG. 17. The example resource usage monitor circuitry 1920 receives current resource usage information from the controller circuitries 1715 and 1720. Resource usage information identifies an amount of cooling resources being used and an amount of power resources being used. The example resource usage monitor circuitry 1920 stores current resource usage information in the resource usage data 1970. The example resource usage data 1970 stores previous resource usages as a collection of resource usages over time.

In some examples, the resource usage monitor circuitry 1920 is instantiated by programmable circuitry executing resource usage monitor instructions and/or configured to perform operations such as those represented by the flowchart of FIG. 21.

In the example of FIG. 19, the example ambient temperature prediction circuitry 1930 is configured to be coupled to the power and cooling distribution circuitry 1705 of FIGS. 17 and 18. The example ambient temperature prediction circuitry 1930 receives the ambient temperature data 1960 from the data store 1950. In some examples, the ambient temperature prediction circuitry 1930 reads the ambient temperature data 1960. The example ambient temperature prediction circuitry 1930 receives the ambient temperature model 1980 from the data store 1950. In some examples, the ambient temperature prediction circuitry 1930 reads the ambient temperature model 1980.

The example ambient temperature prediction circuitry 1930 applies the ambient temperature data 1960 to the ambient temperature model 1980 to generate ambient temperature predictions. In some examples, the ambient temperature model 1980 is a data model, such as a machine learning model, LSTM network, neural network, etc. The example ambient temperature prediction circuitry 1930 supplies the ambient temperature predictions to the power and cooling distribution circuitry 1705.

In some examples, the ambient temperature prediction circuitry 1930 is instantiated by programmable circuitry executing ambient temperature prediction instructions and/or configured to perform operations such as those represented by the flowchart of FIG. 21.

In the example of FIG. 19, the example resource usage prediction circuitry 1940 is configured to be coupled to the power and cooling distribution circuitry 1705. The example resource usage prediction circuitry 1940 receives the resource usage data 1970 from the data store 1950. In some examples, the resource usage prediction circuitry 1940 reads the resource usage data 1970. The example resource usage prediction circuitry 1940 receives the resource usage model 1990 from the data store 1950. In some examples, the resource usage prediction circuitry 1940 reads the resource usage model 1990.

The example resource usage prediction circuitry 1940 applies the resource usage data 1970 to the resource usage model 1990 to generate resource usage predictions. In some examples, the resource usage model 1990 is a data model, such as a machine learning model, LSTM network, neural network, etc. The example resource usage prediction circuitry 1940 supplies the resource usage predictions to the power and cooling distribution circuitry 1705.

In some examples, the resource usage prediction circuitry 1940 is instantiated by programmable circuitry executing resource usage prediction instructions and/or configured to perform operations such as those represented by the flowchart of FIG. 21.

While an example manner of implementing the circuitries 1705 and/or 1710 of FIG. 17 are illustrated in FIGS. 18 and/or 19, one or more of the elements, processes, and/or devices illustrated in FIGS. 18 and 19 may be combined, divided, re-arranged, omitted, eliminated, and/or implemented in any other way. Further, the example compute resource interface circuitry 1810 of FIG. 18, the example SLO generation circuitry 1820 of FIG. 18, the example prediction interface circuitry 1830 of FIG. 18, the example compensation circuitry 1840 of FIG. 18, the example cooling budget circuitry 1850 of FIG. 18, the example power budget circuitry 1860 of FIG. 18, the example balancing circuitry 1870 of FIG. 18, and/or more generally the example power and cooling distribution circuitry 1705 of FIGS. 17 and 18; the example ambient temperature monitor circuitry 1910 of FIG. 19, the example resource usage monitor circuitry 1920 of FIG. 19, the example ambient temperature prediction circuitry 1930 of FIG. 19, the example resource usage prediction circuitry 1940 of FIG. 19, and/or more generally resource prediction circuitry 1710 of FIGS. 17 and 19 may be implemented by hardware alone or by hardware in combination with software and/or firmware. Thus, for example, any of the example compute resource interface circuitry 1810 of FIG. 18, the example SLO generation circuitry 1820 of FIG. 18, the example prediction interface circuitry 1830 of FIG. 18, the example compensation circuitry 1840 of FIG. 18, the example cooling budget circuitry 1850 of FIG. 18, the example power budget circuitry 1860 of FIG. 18, the example balancing circuitry 1870 of FIG. 18, and/or more generally the example power and cooling distribution circuitry 1705 of FIGS. 17 and 18; the example ambient temperature monitor circuitry 1910 of FIG. 19, the example resource usage monitor circuitry 1920 of FIG. 19, the example ambient temperature prediction circuitry 1930 of FIG. 19, the example resource usage prediction circuitry 1940 of FIG. 19, and/or more generally resource prediction circuitry 1710 of FIGS. 17 and 19, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example circuitries 1705 and 1710 of FIGS. 17, 18, and 19 may include one or more elements, processes, and/or devices in addition to, or instead of, those illustrated in FIGS. 18 and 19, and/or may include more than one of any or all of the illustrated elements, processes and devices.

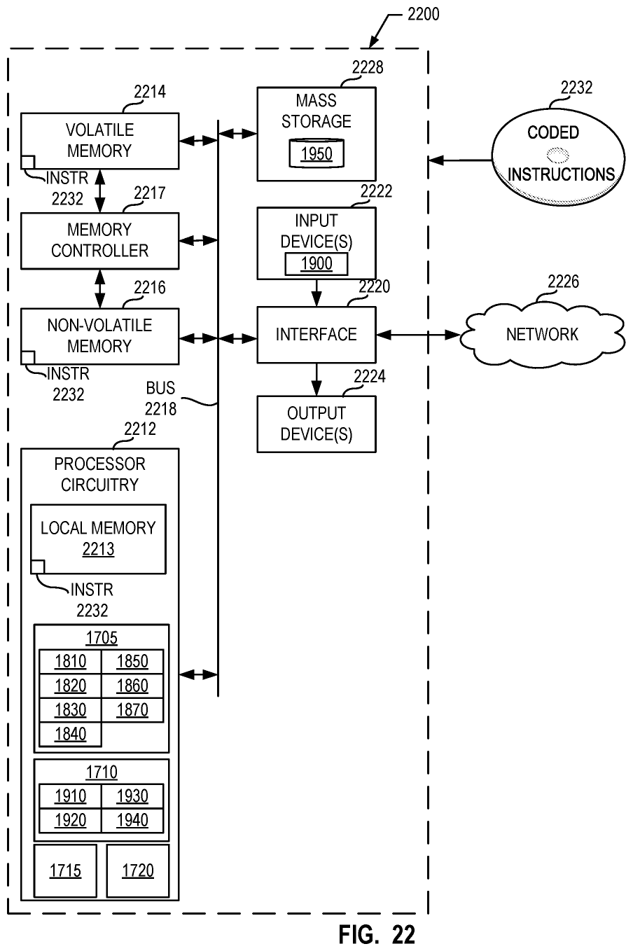

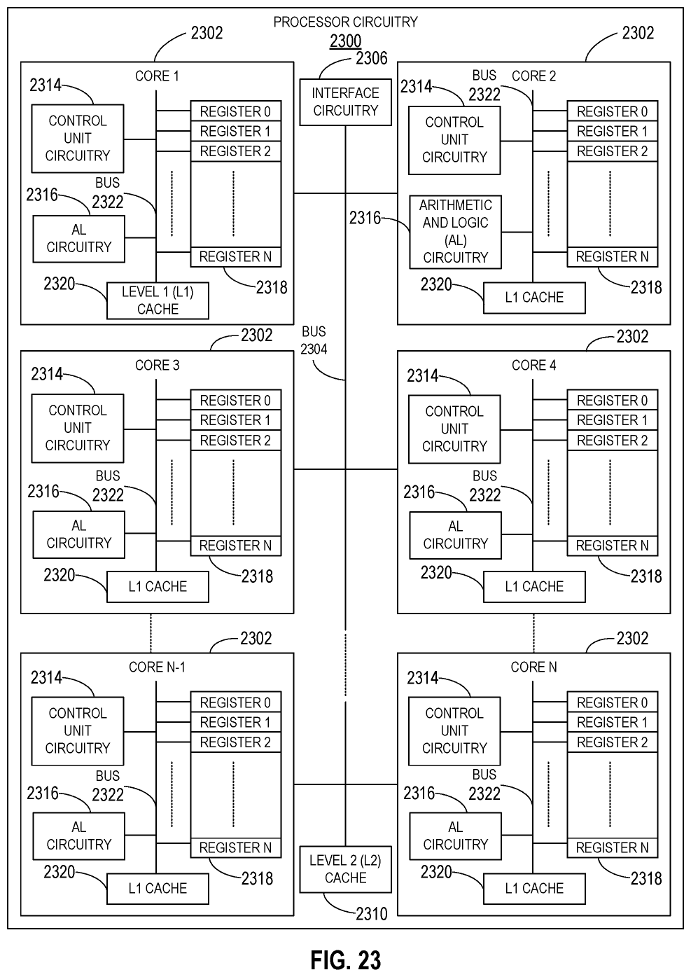

Example machine-readable instructions may be executed to configure programmable circuitry to implement the example circuitries 1705 and 1710 of FIGS. 17, 18, and 19. The machine-readable instructions may be one or more executable programs or portion(s) of an executable program for execution by programmable circuitry, such as the programmable circuitry 2212 shown in the example programmable circuitry platform 2200 discussed below in connection with FIG. 22 and/or the example programmable circuitry discussed below in connection with FIGS. 23 and/or 24. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with programmable circuitry located in one or more hardware devices, but the entire program and/or parts thereof could alternatively be executed by one or more hardware devices other than the programmable circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 20 and 21, many other methods of implementing the example power and cooling distribution circuitry 1705 and the example resource prediction circuitry 1710 may alternatively be used. Additionally or alternatively, any or all of the machine-readable instructions may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine-readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable media, as used herein, may include machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 20 and 21 may be implemented using executable instructions (e.g., computer and/or machine-readable instructions) be stored on one or more non-transitory computer and/or machine-readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine-readable medium, and non-transitory machine-readable storage medium are expressly defined to include any type of computer readable storage device and/or storage disk and to exclude propagating signals and to exclude transmission media. As used herein, the terms “computer readable storage device” and “machine-readable storage device” are defined to include any physical (mechanical and/or electrical) structure to store information, but to exclude propagating signals and to exclude transmission media. Examples of computer readable storage devices and machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 20 is a flowchart representative of example machine-readable instructions and/or example operations of the power and cooling distribution circuitry 1705 of FIGS. 17 and 18 that may be executed and/or instantiated by programmable circuitry to perform operations to balance and coordinate power and cooling resources. The machine-readable instructions and/or the operations 2000 of FIG. 20 begin at block 2005, at which the example compute resource interface circuitry 1810 of FIG. 18 receives a service level agreement (e.g., one of the SLAs 1772 of FIG. 17) and resource data (e.g., the resource data 1774, 1785, and 1790 of FIG. 17). In some examples, the SLAs 1772 include identification information corresponding to compute resources (e.g., the CPU 1730 of FIG. 17, the memory 1745 of FIG. 17, and the additional resource 1760 of FIG. 17) of a computing system (e.g., the computing system 1700 of FIG. 17). In such examples, the resource data 1774, 1785, and 1790 includes identifiers of the identification information to identify corresponding compute resources of the computing system. The example compute resource interface circuitry 1810 receives the SLAs 1772 from the CPU 1730 of FIG. 17. The example compute resource interface circuitry 1810 receives the resource data 1774, 1785, and 1790 from the CPU 1730, the memory 1745 of FIG. 17, and/or the additional resource 1760 of FIG. 17.

The example SLO generation circuitry 1820 of FIG. 18 determines a service level objective based on the service level agreement and the resource data. (Block 2010). In some examples, the SLO generation circuitry 1820 selects thresholds of the resource data 1774, 1785, and 1790 that satisfy the SLAs 1772. In such examples, the SLO generation circuitry 1820 maps the SLAs 1772 to the thresholds of the resource data 1774, 1785, and/or 1790.

The example prediction interface circuitry 1830 of FIG. 18 receives ambient temperature predictions and resource usage predictions. (Block 2015). The example prediction interface circuitry 1830 receives the ambient temperature predictions and the resources usage predictions from the resource prediction circuitry 1710 of FIGS. 17 and 19. Example operations to determine the ambient temperature predictions and the resources usage predictions are discussed in FIG. 22, below.

The example compensation circuitry 1840 of FIG. 18 modifies the service level objective to generate a modified service level objective based on the ambient temperature predictions. (Block 2020). In some examples, the compensation circuitry 1840 modifies threshold selections of the SLOs to compensate for ambient temperatures. In such examples, the compensation circuitry 1840 selects modified thresholds based on a difference an ambient temperature of the thresholds of the resource data 1774, 1785, and 1790 and a current ambient temperature.

The example cooling budget circuitry 1850 of FIG. 18 determines a cooling budget using the resource usage predictions. (Block 2025). In some examples, the cooling budget circuitry 1850 determines a resource budget (a cooling budget) for any given time by subtracting cooling resource usage predictions from a total amount of accessible cooling resources. In such examples, the cooling budget circuitry 1850 determines the resource budget for a given time to be available cooling resources that may be allocated.

The example power budget circuitry 1860 of FIG. 18 determines a power budget using the resource usage predictions. (Block 2030). In some examples, the power budget circuitry 1860 determines a resource budget (a power budget) for any given time by subtracting power resource usage predictions from a total amount of accessible power resources. In such examples, the power budget circuitry 1860 determines the resource budget for a given time to be available power resources that may be allocated.

The example balancing circuitry 1870 of FIG. 18 determines if there are enough available resources to satisfy the modified service level objective. (Block 2035). In some examples, the balancing circuitry 1870 compares the modified SLOs from Block 2020 to the available cooling resources from Block 2025 and the available power resources from Block 2030. In such examples, the balancing circuitry 1870 determines whether a combination of the available resources could be used to satisfy the modified SLOs.

If the example balancing circuitry 1870 determines there are enough available resources to satisfy the compensated service level objectives (e.g., Block 2035 returns a result of YES), the balancing circuitry 1870 generates resource allocation information using the modified service level objective and the available resources. (Block 2040). The example balancing circuitry 1870 balances the available resources from Blocks 2025 and 2030 to determine the resource allocation information. In some examples, the balancing circuitry 1870 balances usage of the available cooling resources with the available power resources to increase performance efficiency, such as performance per watt. In other examples, the balancing circuitry 1870 balances usage of the available cooling resources with the available power resources to increase resource usage. For example, the balancing circuitry 1870 may decrease cooling and increase power supplied to a resource. In such an example, the resource is capable of managing relatively high temperatures without external cooling and there is an access of power resources.

The example budget circuitries 1850 and 1860 cause allocation of the available resources based on the resource allocation information. (Block 2045). In some examples, the cooling budget circuitry 1850 supplies the cooling resource allocation information to the cooling controller circuitry 1715 of FIG. 17. In such examples, the cooling controller circuitry 1715 controls the cooling distribution system 1725 of FIG. 17 to control distribution of the cooling resources (e.g., increasing or decreasing coolant flow to one or more the cooling systems 1735, 1750, 1765). Additionally or alternatively, the power budget circuitry 1860 supplies the power resource allocation information to the power controller circuitry 1720 of FIG. 17. In such examples, the power controller circuitry 1720 controls the power systems 1740, 1755, and/or 1770 to distribute power resources. Control proceeds to end.

If the balancing circuitry 1870 determines there are not enough available resources to satisfy the compensated service level agreements that have a relatively high level of service (e.g., Block 2035 returns a result of NO), the example compute resource interface circuitry 1810 requests a modified service level agreement. (Block 2050). In some examples, the compute resource interface circuitry 1810 requests a modified SLA by rejecting the SLA. In other examples, the compute resource interface circuitry 1810 may postpone an operation by rejecting the SLA. Control proceeds to end.

Although example processes are described with reference to the flowchart illustrated in FIG. 20, many other methods of balancing and coordinating power and cooling resources may alternatively be used in accordance with teachings of this disclosure. For example, the order of execution of the blocks may be changed, and/or some of the blocks described may be changed, eliminated, or combined. Similarly, additional operations may be included in the manufacturing process before, in between, or after the blocks shown in the illustrated examples.

FIG. 21 is a flowchart representative of example machine-readable instructions and/or example operations of the resource prediction circuitry 1710 of FIGS. 17 and 19 that may be executed and/or instantiated by programmable circuitry to perform operations to generate ambient temperature predictions and resource usage predictions. The machine-readable instructions and/or the operations 2100 of FIG. 21 begin at block 2110, at which the example ambient temperature monitor circuitry 1910 of FIG. 19 determines an ambient temperature. In some examples, the ambient temperature monitor circuitry 1910 determines the ambient temperature based on a current ambient temperature measurement or value from the ambient temperature sensor 1900 of FIG. 19. In such examples, the ambient temperature corresponds to a temperature of the environment of the computing system 1700.

The example ambient temperature prediction circuitry 1930 of FIG. 19 generates ambient temperature predictions using the ambient temperature model 1980 of FIG. 19 and previously measured ambient temperature data. (Block 2120). In some examples, the ambient temperature prediction circuitry 1930 applies the ambient temperature from Block 2110 to the ambient temperature model 1980 to predict a subsequent ambient temperature. In such examples, the ambient temperature prediction circuitry 1930 may generate a plurality of ambient temperature predictions, such as for a specified amount of future time, using the ambient temperature data 1960 of FIG. 19.

The example resource usage monitor circuitry 1920 of FIG. 19 determines resource usage. (Block 2130). In some examples, the resource usage monitor circuitry 1920 uses the cooling controller circuitry 1715 and the power controller circuitry 1720 to determine a current resource usage. In other examples, the resource usage monitor circuitry 1920 may use allocation information from the power and cooling distribution circuitry 1705 of FIGS. 17 and 18 to determine a current resource usage.

The example resource usage prediction circuitry 1940 of FIG. 19 generates resource usage predictions using the resource usage model 1990 of FIG. 19 and previously determined resource usage. (Block 2140). In some examples, the resource usage prediction circuitry 1940 applies the resource usage from Block 2130 to the resource usage model 1990 to predict a subsequent resource usage. In such examples, the resource usage prediction circuitry 1940 may generate a plurality of resources usage predictions, such as for a specified amount of future time, using the resource usage data 1970 of FIG. 19.

The example prediction circuitries 1930 and 1940 supply the ambient temperature predictions and the resource usage predictions to the power and cooling distribution circuitry 1705. (Block 2150). Control proceeds to end.

Although example processes are described with reference to the flowchart illustrated in FIG. 21, many other methods of predicting ambient temperatures and resource usage may alternatively be used in accordance with teachings of this disclosure. For example, the order of execution of the blocks may be changed, and/or some of the blocks described may be changed, eliminated, or combined. Similarly, additional operations may be included in the manufacturing process before, in between, or after the blocks shown in the illustrated examples.

FIG. 22 is a block diagram of an example programmable circuitry platform 2200 structured to execute and/or instantiate machine-readable instructions and/or operations to implement the circuitry of the example computing system 1700 of FIG. 17. The programmable circuitry platform 2200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The programmable circuitry platform 2200 of the illustrated example includes programmable circuitry 2212. The programmable circuitry 2212 of the illustrated example is hardware. For example, the programmable circuitry 2212 can be implemented by one or more integrated circuits, logic circuits, FPGAs, microprocessors, CPUs, GPUs, DSPs, and/or microcontrollers from any desired family or manufacturer. The programmable circuitry 2212 may be implemented by one or more semiconductor based (e.g., silicon based) devices. In this example, the programmable circuitry 2212 implements the example compute resource interface circuitry 1810 of FIG. 18, the example SLO generation circuitry 1820 of FIG. 18, the example prediction interface circuitry 1830 of FIG. 18, the example compensation circuitry 1840 of FIG. 18, the example cooling budget circuitry 1850 of FIG. 18, the example power budget circuitry 1860 of FIG. 18, the example balancing circuitry 1870 of FIG. 18, and/or more generally the example power and cooling distribution circuitry 1705 of FIGS. 17 and 18; the example ambient temperature monitor circuitry 1910 of FIG. 19, the example resource usage monitor circuitry 1920 of FIG. 19, the example ambient temperature prediction circuitry 1930 of FIG. 19, the example resource usage prediction circuitry 1940 of FIG. 19, and/or more generally resource prediction circuitry 1710 of FIGS. 17 and 19; and the controller circuitries 1715 and 1720 of FIG. 17.

The programmable circuitry 2212 of the illustrated example includes a local memory 2213 (e.g., a cache, registers, etc.). The programmable circuitry 2212 of the illustrated example is in communication with a main memory including a volatile memory 2214 and a non-volatile memory 2216 by a bus 2218. The volatile memory 2214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2216 may be implemented by flash memory and/or any other desired type of memory device. Access to the main memory 2214, 2216 of the illustrated example is controlled by a memory controller 2217.

The programmable circuitry platform 2200 of the illustrated example also includes interface circuitry 2220. The interface circuitry 2220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 2222 are connected to the interface circuitry 2220. The input device(s) 2222 permit(s) a device and/or a user to enter data and/or commands into the programmable circuitry 2212. In input device(s) 2222 can include the ambient temperature sensor 1900. Additionally or alternatively, the input device(s) 2222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 2224 are also connected to the interface circuitry 2220 of the illustrated example. The output device(s) 2224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 2220 of the illustrated example, thus, typically includes a graphics driver card, a graphics driver chip, and/or graphics programmable circuitry such as a GPU.

The interface circuitry 2220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 2226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 2200 of the illustrated example also includes one or more mass storage devices 2228 to store software and/or data. Examples of such mass storage devices 2228 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

Machine-readable instructions 2232, which may be implemented by the machine-readable instructions of FIGS. 20 and 21, may be stored in the mass storage device 2228, in the volatile memory 2214, in the non-volatile memory 2216, and/or on a removable non-transitory computer readable storage medium such as a CD or DVD.

FIG. 23 is a block diagram of an example implementation of the programmable circuitry 2212 of FIG. 22. In this example, the programmable circuitry 2212 of FIG. 22 is implemented by a microprocessor 2300. For example, the microprocessor 2300 may be a general-purpose microprocessor (e.g., general purpose microprocessor circuitry). The microprocessor 2300 executes some or all of the machine-readable instructions to effectively instantiate the circuitry of FIG. 17 as logic circuits to perform the operations corresponding to those machine-readable instructions. In some such examples, the circuitry of FIG. 17 is instantiated by the hardware circuits of the microprocessor 2300 in combination with the instructions. For example, the microprocessor 2300 may be implemented by multi-core hardware circuitry such as a CPU, a DSP, a GPU, an XPU, etc. Although it may include any number of example cores 2302 (e.g., 1 core), the microprocessor 2300 of this example is a multi-core semiconductor device including N cores. The cores 2302 of the microprocessor 2300 may operate independently or may cooperate to execute machine-readable instructions. For example, machine code corresponding to a firmware program, an embedded software program, or a software program may be executed by one of the cores 2302 or may be executed by multiple ones of the cores 2302 at the same or different times. In some examples, the machine code corresponding to the firmware program, the embedded software program, or the software program is split into threads and executed in parallel by two or more of the cores 2302. The software program may correspond to a portion or all of the machine-readable instructions and/or operations.

The cores 2302 may communicate by a first example bus 2304. In some examples, the first bus 2304 may be implemented by a communication bus to effectuate communication associated with one(s) of the cores 2302. For example, the first bus 2304 may be implemented by at least one of an Inter-Integrated Circuit (I2C) bus, a Serial Peripheral Interface (SPI) bus, a PCI bus, or a PCIe bus. Additionally or alternatively, the first bus 2304 may be implemented by any other type of computing or electrical bus. The cores 2302 may obtain data, instructions, and/or signals from one or more external devices by example interface circuitry 2306. The cores 2302 may output data, instructions, and/or signals to the one or more external devices by the interface circuitry 2306. Although the cores 2302 of this example include example local memory 2320 (e.g., Level 1 (L1) cache that may be split into an L1 data cache and an L1 instruction cache), the microprocessor 2300 also includes example shared memory 2310 that may be shared by the cores (e.g., Level 2 (L2 cache)) for high-speed access to data and/or instructions. Data and/or instructions may be transferred (e.g., shared) by writing to and/or reading from the shared memory 2310. The local memory 2320 of each of the cores 2302 and the shared memory 2310 may be part of a hierarchy of storage devices including multiple levels of cache memory and the main memory (e.g., the main memory 2214, 2216 of FIG. 22). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 2302 may be referred to as a CPU, DSP, GPU, etc., or any other type of hardware circuitry. Each core 2302 includes control unit circuitry 2314, arithmetic and logic (AL) circuitry (sometimes referred to as an ALU) 2316, a plurality of registers 2318, the local memory 2320, and a second example bus 2322. Other structures may be present. For example, each core 2302 may include vector unit circuitry, single instruction multiple data (SIMD) unit circuitry, load/store unit (LSU) circuitry, branch/jump unit circuitry, floating-point unit (FPU) circuitry, etc. The control unit circuitry 2314 includes semiconductor-based circuits structured to control (e.g., coordinate) data movement within the corresponding core 2302. The AL circuitry 2316 includes semiconductor-based circuits structured to perform one or more mathematic and/or logic operations on the data within the corresponding core 2302. The AL circuitry 2316 of some examples performs integer-based operations. In other examples, the AL circuitry 2316 also performs floating point operations. In yet other examples, the AL circuitry 2316 may include first AL circuitry that performs integer-based operations and second AL circuitry that performs floating point operations. In some examples, the AL circuitry 2316 may be referred to as an Arithmetic Logic Unit (ALU). The registers 2318 are semiconductor-based structures to store data and/or instructions such as results of one or more of the operations performed by the AL circuitry 2316 of the corresponding core 2302. For example, the registers 2318 may include vector register(s), SIMD register(s), general purpose register(s), flag register(s), segment register(s), machine specific register(s), instruction pointer register(s), control register(s), debug register(s), memory management register(s), machine check register(s), etc. The registers 2318 may be arranged in a bank as shown in FIG. 23. Alternatively, the registers 2318 may be organized in any other arrangement, format, or structure including distributed throughout the core 2302 to shorten access time. The second bus 2322 may be implemented by at least one of an I2C bus, a SPI bus, a PCI bus, or a PCIe bus.

Each core 2302 and/or, more generally, the microprocessor 2300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 2300 is a semiconductor device fabricated to include many transistors interconnected to implement the structures described above in one or more integrated circuits (ICs) contained in one or more packages. The programmable circuitry may include and/or cooperate with one or more accelerators. In some examples, accelerators are implemented by logic circuitry to perform certain tasks more quickly and/or efficiently than can be done by a general-purpose processor. Examples of accelerators include ASICs and FPGAs such as those discussed herein. A GPU or other programmable device can also be an accelerator. Accelerators may be on-board the programmable circuitry, in the same chip package as the programmable circuitry and/or in one or more separate packages from the programmable circuitry.

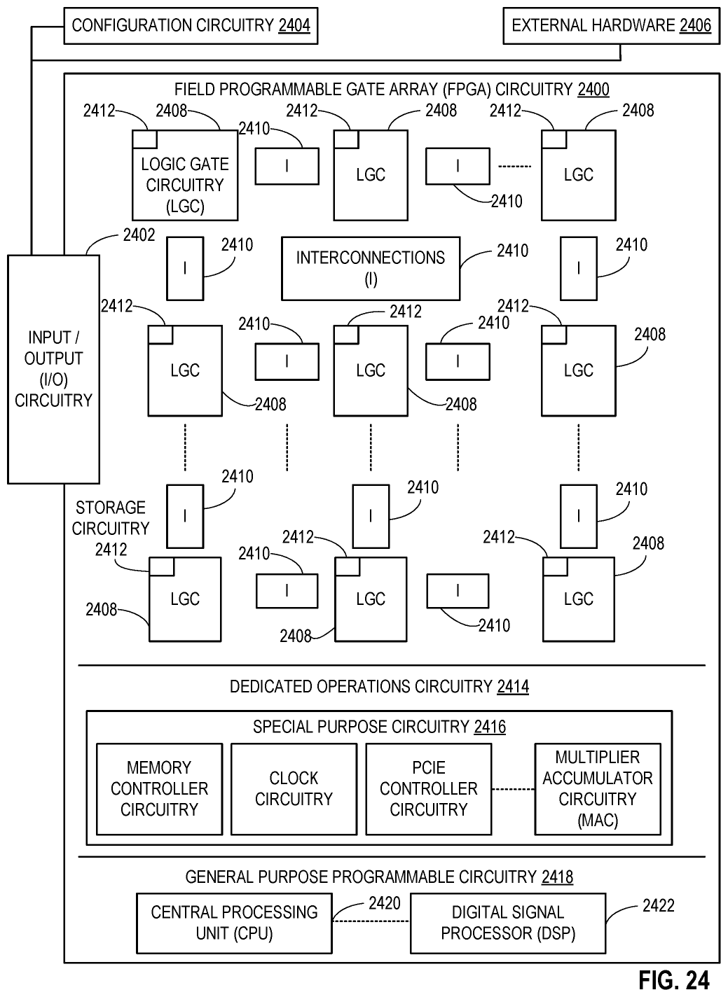

FIG. 24 is a block diagram of another example implementation of the programmable circuitry 2212 of FIG. 22. In this example, the programmable circuitry 2212 is implemented by FPGA circuitry 2400. For example, the FPGA circuitry 2400 may be implemented by an FPGA. The FPGA circuitry 2400 can be used, for example, to perform operations that could otherwise be performed by the example microprocessor 2300 of FIG. 23 executing corresponding machine-readable instructions. However, once configured, the FPGA circuitry 2400 instantiates the machine-readable instructions in hardware and, thus, can often execute the operations faster than they could be performed by a general-purpose microprocessor executing the corresponding software.

More specifically, in contrast to the microprocessor 2300 of FIG. 23 described above (which is a general purpose device that may be programmed to execute some or all of the machine-readable instructions but whose interconnections and logic circuitry are fixed once fabricated), the FPGA circuitry 2400 of the example of FIG. 24 includes interconnections and logic circuitry that may be configured and/or interconnected in different ways after fabrication to instantiate, for example, some or all of the machine-readable instructions. In particular, the FPGA circuitry 2400 may be thought of as an array of logic gates, interconnections, and switches. The switches can be programmed to change how the logic gates are interconnected by the interconnections, effectively forming one or more dedicated logic circuits (unless and until the FPGA circuitry 2400 is reprogrammed). The configured logic circuits enable the logic gates to cooperate in different ways to perform different operations on data received by input circuitry. Those operations may correspond to some or all of the software. As such, the FPGA circuitry 2400 may be structured to effectively instantiate some or all of the machine-readable instructions as dedicated logic circuits to perform the operations corresponding to those software instructions in a dedicated manner analogous to an ASIC. Therefore, the FPGA circuitry 2400 may perform the operations corresponding to the some or all of the machine-readable instructions faster than the general-purpose microprocessor can execute the same.

In the example of FIG. 24, the FPGA circuitry 2400 is structured to be programmed (and/or reprogrammed one or more times) by an end user by a hardware description language (HDL) such as Verilog. The FPGA circuitry 2400 of FIG. 24, includes example input/output (I/O) circuitry 2402 to obtain and/or output data to/from example configuration circuitry 2404 and/or external hardware 2406. For example, the configuration circuitry 2404 may be implemented by interface circuitry that may obtain machine-readable instructions to configure the FPGA circuitry 2400, or portion(s) thereof. In some such examples, the configuration circuitry 2404 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 2406 may be implemented by external hardware circuitry. For example, the external hardware 2406 may be implemented by the microprocessor 2300 of FIG. 23. The FPGA circuitry 2400 also includes an array of example logic gate circuitry 2408, a plurality of example configurable interconnections 2410, and example storage circuitry 2412. The logic gate circuitry 2408 and the configurable interconnections 2410 are configurable to instantiate one or more operations that may correspond to at least some of the machine-readable instructions and/or other desired operations. The logic gate circuitry 2408 shown in FIG. 24 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2408 to enable configuration of the electrical structures and/or the logic gates to form circuits to perform desired operations. The logic gate circuitry 2408 may include other electrical structures such as look-up tables (LUTs), registers (e.g., flip-flops or latches), multiplexers, etc.

The configurable interconnections 2410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2408 to program desired logic circuits.

The storage circuitry 2412 of the illustrated example is structured to store result(s) of the one or more of the operations performed by corresponding logic gates. The storage circuitry 2412 may be implemented by registers or the like. In the illustrated example, the storage circuitry 2412 is distributed amongst the logic gate circuitry 2408 to facilitate access and increase execution speed.

The example FPGA circuitry 2400 of FIG. 24 also includes example Dedicated Operations Circuitry 2414. In this example, the Dedicated Operations Circuitry 2414 includes special purpose circuitry 2416 that may be invoked to implement commonly used functions to avoid the need to program those functions in the field. Examples of such special purpose circuitry 2416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2400 may also include example general purpose programmable circuitry 2418 such as an example CPU 2420 and/or an example DSP 2422. Other general purpose programmable circuitry 2418 may additionally or alternatively be present such as a GPU, an XPU, etc., that can be programmed to perform other operations.

Although FIGS. 20 and 21 illustrate two example implementations of the programmable circuitry 2212 of FIG. 22, many other approaches are contemplated. For example, as mentioned above, modern FPGA circuitry may include an on-board CPU, such as one or more of the example CPU 2420 of FIG. 24. Therefore, the programmable circuitry 2212 of FIG. 22 may additionally be implemented by combining the example microprocessor 2300 of FIG. 23 and the example FPGA circuitry 2400 of FIG. 24. In some such hybrid examples, a first portion of the machine-readable instructions may be executed by one or more of the cores 2302 of FIG. 23, a second portion of the machine-readable instructions may be executed by the FPGA circuitry 2400 of FIG. 24, and/or a third portion of the machine-readable instructions may be executed by an ASIC. It should be understood that some or all of the circuitry of FIG. 17 may, thus, be instantiated at the same or different times. Some or all of the circuitry may be instantiated, for example, in one or more threads executing concurrently and/or in series. Moreover, in some examples, some or all of the circuitry of FIG. 17 may be implemented within one or more virtual machines and/or containers executing on the microprocessor.

In some examples, the programmable circuitry 2212 of FIG. 22 may be in one or more packages. For example, the microprocessor 2300 of FIG. 23 and/or the FPGA circuitry 2400 of FIG. 24 may be in one or more packages. In some examples, an XPU may be implemented by the programmable circuitry 2212 of FIG. 22, which may be in one or more packages. For example, the XPU may include a CPU in one package, a DSP in another package, a GPU in yet another package, and an FPGA in still yet another package.

From the foregoing, it will be appreciated that example systems, methods, apparatus, and articles of manufacture have been disclosed that balance and coordinate power and cooling resources in a system. Disclosed systems, methods, apparatus, and articles of manufacture improve the efficiency of using a computing device by balancing resource usage. Disclosed systems, methods, apparatus, and articles of manufacture are accordingly directed to one or more improvement(s) in the operation of a machine such as a computer or other electronic and/or mechanical device. Further examples and combinations thereof include the following.

Example 1 includes an apparatus comprising memory, machine-readable instructions, and programmable circuitry to execute the machine-readable instructions to determine a first service level objective based on a service level agreement and resource data, modify the first service level objective to generate a second service level objective based on the first service level objective and an ambient temperature prediction, determine a resource budget based on a resource usage prediction, the resource budget to identify available resources at a given time, and cause an allocation of cooling resources and power resources for a compute component based on the second service level objective and the resource budget.

Example 2 includes the apparatus of example 1, wherein the programmable circuitry is to generate the second service level objective by selecting a power threshold of the resource data, the power threshold to satisfy the service level agreement.

Example 3 includes the apparatus of example 1, wherein the programmable circuitry is to generate the resource usage prediction based on a current resource usage, previous resource usage, and a resource usage model.

Example 4 includes the apparatus of example 1, wherein the programmable circuitry is to generate the ambient temperature prediction based on a current ambient temperature, previous ambient temperatures, and an ambient temperature model.

Example 5 includes the apparatus of example 1, wherein the resource budget is a first resource budget, the available resources are first available resources, the programmable circuitry is to generate a second resource budget based on the resource usage prediction, the second resource budget to identify second available resources.

Example 6 includes the apparatus of example 1, wherein the programmable circuitry is to generate the resource budget by allocating a portion of accessible cooling resources for future use, the portion based on the resource usage prediction.

Example 7 includes the apparatus of example 1, wherein the programmable circuitry is to coordinate the allocation of cooling resources and power resources to at least one of increase resource usage, increase energy efficiency, or increase performance per watt.

Example 8 includes At least one non-transitory computer readable storage medium comprising instructions that, when executed, cause programmable circuitry to at least determine a first service level objective based on a service level agreement and resource data, modify the first service level objective to generate a second service level objective based on the first service level objective, and an ambient temperature prediction, determine a resource budget based on a resource usage prediction, the resource budget to identify available resources at a given time, and cause an allocation of cooling resources and power resources for a compute component based on the second service level objective and the resource budget.

Example 9 includes the at least one non-transitory computer readable storage medium of example 8, wherein the instructions are to cause the programmable circuitry to generate the second service level objective by selecting a power threshold of the resource data, the power threshold to satisfy the service level agreement.

Example 10 includes the at least one non-transitory computer readable storage medium of example 8, wherein the instructions are to cause the programmable circuitry to generate the resource usage prediction based on a current resource usage, previous resource usage, and a resource usage model.

Example 11 includes the at least one non-transitory computer readable storage medium of example 8, wherein the instructions are to cause the programmable circuitry to generate the ambient temperature prediction based on a current ambient temperature, previous ambient temperatures, and an ambient temperature model.

Example 12 includes the at least one non-transitory computer readable storage medium of example 8, wherein the resource budget is a first resource budget, the available resources are first available resources, the instructions are to cause the programmable circuitry to generate a second resource budget based on the resource usage prediction, the second resource budget to identify second available resources.

Example 13 includes the at least one non-transitory computer readable storage medium of example 8, wherein the instructions are to cause the programmable circuitry to generate the resource budget by allocating a portion of accessible cooling resources for future use, the portion based on the resource usage prediction.

Example 14 includes the at least one non-transitory computer readable storage medium of example 8, wherein the instructions are to cause the programmable circuitry to coordinate the allocation of cooling resources and power resources to at least one of increase resource usage, increase energy efficiency, or increase performance per watt.

Example 15 includes a method comprising determining, by service level objective generation circuitry, a first service level objective based on a service level agreement and resource data, modifying, by compensation circuitry, the first service level objective to generate a second service level objective based on the first service level objective, and an ambient temperature prediction, determining, by budget circuitry, a resource budget based on a resource usage prediction, the resource budget to identify available resources at a given time, and causing, by the budget circuitry, an allocation of cooling resources and power resources for a compute component based on the second service level objective and the resource budget.

Example 16 includes the method of example 15, further including generating the second service level objective by selecting a power threshold of the resource data, the power threshold to satisfy the service level agreement.

Example 17 includes the method of example 15, further including generating the resource usage prediction based on a current resource usage, previous resource usage, and a resource usage model.

Example 18 includes the method of example 15, further including generating the ambient temperature prediction based on a current ambient temperature, previous ambient temperatures, and an ambient temperature model.

Example 19 includes the method of example 15, wherein the resource budget is a first resource budget, the available resources are first available resources, further including generating a second resource budget based on the resource usage prediction, the second resource budget to identify second available resources.

Example 20 includes the method of example 15, further including generating the resource budget by allocating a portion of accessible cooling resources for future use, the portion based on the resource usage prediction.

Example 21 includes the method of example 15, further including coordinating the allocation of cooling resources and power resources to at least one of increase resource usage, increase energy efficiency, or increase performance per watt.

What is claimed is:

1. An apparatus comprising:
memory;
machine-readable instructions; and
programmable circuitry to execute the machine-readable instructions to:
determine a first service level objective based on a service level agreement and resource data;
modify the first service level objective to generate a second service level objective based on the first service level objective and an ambient temperature prediction;
determine a resource budget based on a resource usage prediction, the resource budget to identify available resources at a given time; and
cause an allocation of cooling resources and power resources for a compute component based on the second service level objective and the resource budget.

2. The apparatus of claim 1, wherein the programmable circuitry is to generate the second service level objective by selecting a power threshold of the resource data, the power threshold to satisfy the service level agreement.

3. The apparatus of claim 1, wherein the programmable circuitry is to generate the resource usage prediction based on a current resource usage, previous resource usage, and a resource usage model.

4. The apparatus of claim 1, wherein the programmable circuitry is to generate the ambient temperature prediction based on a current ambient temperature, previous ambient temperatures, and an ambient temperature model.

5. The apparatus of claim 1, wherein the resource budget is a first resource budget, the available resources are first available resources, the programmable circuitry is to generate a second resource budget based on the resource usage prediction, the second resource budget to identify second available resources.

6. The apparatus of claim 1, wherein the programmable circuitry is to generate the resource budget by allocating a portion of accessible cooling resources for future use, the portion based on the resource usage prediction.

7. The apparatus of claim 1, wherein the programmable circuitry is to coordinate the allocation of cooling resources and power resources to at least one of increase resource usage, increase energy efficiency, or increase performance per watt.

8. At least one non-transitory computer readable storage medium comprising instructions that, when executed, cause programmable circuitry to at least:
determine a first service level objective based on a service level agreement and resource data;
modify the first service level objective to generate a second service level objective based on the first service level objective, and an ambient temperature prediction;
determine a resource budget based on a resource usage prediction, the resource budget to identify available resources at a given time; and
cause an allocation of cooling resources and power resources for a compute component based on the second service level objective and the resource budget.

9. The at least one non-transitory computer readable storage medium of claim 8, wherein the instructions are to cause the programmable circuitry to generate the second service level objective by selecting a power threshold of the resource data, the power threshold to satisfy the service level agreement.

10. The at least one non-transitory computer readable storage medium of claim 8, wherein the instructions are to cause the programmable circuitry to generate the resource usage prediction based on a current resource usage, previous resource usage, and a resource usage model.

11. The at least one non-transitory computer readable storage medium of claim 8, wherein the instructions are to cause the programmable circuitry to generate the ambient temperature prediction based on a current ambient temperature, previous ambient temperatures, and an ambient temperature model.

12. The at least one non-transitory computer readable storage medium of claim 8, wherein the resource budget is a first resource budget, the available resources are first available resources, the instructions are to cause the programmable circuitry to generate a second resource budget based on the resource usage prediction, the second resource budget to identify second available resources.

13. The at least one non-transitory computer readable storage medium of claim 8, wherein the instructions are to cause the programmable circuitry to generate the resource budget by allocating a portion of accessible cooling resources for future use, the portion based on the resource usage prediction.

14. The at least one non-transitory computer readable storage medium of claim 8, wherein the instructions are to cause the programmable circuitry to coordinate the allocation of cooling resources and power resources to at least one of increase resource usage, increase energy efficiency, or increase performance per watt.

15. A method comprising:
determining, by service level objective generation circuitry, a first service level objective based on a service level agreement and resource data;
modifying, by compensation circuitry, the first service level objective to generate a second service level objective based on the first service level objective, and an ambient temperature prediction;
determining, by budget circuitry, a resource budget based on a resource usage prediction, the resource budget to identify available resources at a given time; and
causing, by the budget circuitry, an allocation of cooling resources and power resources for a compute component based on the second service level objective and the resource budget.

16. The method of claim 15, further including generating the second service level objective by selecting a power threshold of the resource data, the power threshold to satisfy the service level agreement.

17. The method of claim 15, further including generating the resource usage prediction based on a current resource usage, previous resource usage, and a resource usage model.

18. The method of claim 15, further including generating the ambient temperature prediction based on a current ambient temperature, previous ambient temperatures, and an ambient temperature model.

19. The method of claim 15, wherein the resource budget is a first resource budget, the available resources are first available resources, further including generating a second resource budget based on the resource usage prediction, the second resource budget to identify second available resources.

20. The method of claim 15, further including generating the resource budget by allocating a portion of accessible cooling resources for future use, the portion based on the resource usage prediction.
